(19) United States
(12) Patent Application Publication
(10) Pub. No.: US 2020/0227007 A1
(43) Pub. Date: Jul. 16, 2020

(54) DISPLAY SYSTEM, CONTROL METHOD OF DISPLAY SYSTEM, INFORMATION PROCESSING DEVICE, AND CONTROL PROGRAM OF INFORMATION PROCESSING DEVICE

(71) Applicant: SEIKO EPSON CORPORATION, Tokyo (JP)

(72) Inventors: Atsushi OI, Ueda-shi (JP); Yusuke OMORI, Saku-shi (JP); Ai HARADA, Ueda-shi (JP)

(73) Assignee: SEIKO EPSON CORPORATION, Tokyo (JP)

(21) Appl. No.: 16/738,229

(22) Filed: Jan. 9, 2020

(30) Foreign Application Priority Data
Jan. 10, 2019 (JP) 2019-002681

(51) Int. Cl. G09G 5/14; G06F 3/01

(52) U.S. Cl. CPC G09G 5/14; G09G 2354/00; G06F 3/011

(57) ABSTRACT

A display system is constituted of a smartphone and an HMD that are connected to each other. The HMD is mounted on a head of a user, and includes an image display unit configured to display an image, a reception unit configured to receive the image from the smartphone, and a first display controller configured to divide the image at a set division position, generate a plurality of divided images, and cause the image display unit to display each of the divided images. Further, the smartphone includes a transmission unit configured to transmit, to the HMD, image data corresponding to the image, and a second display controller configured to separate a position of an adjustment object away from a position corresponding to the division position in a case where the image includes the adjustment object for adjusting the image.

The present application is based on, and claims priority from JP Application Serial Number 2019-002681, filed Jan. 10, 2019, the disclosure of which is hereby incorporated by reference herein in its entirety.

### BACKGROUND

### 1. Technical Field

The present disclosure relates to a display system, a control method of the display system, an information processing device, and a control program of the information processing device.

### 2. Related Art

A display device that displays 3D contents is known (see, for example, JP-A-2013-33172).

A stereoscopic display device described in JP-A-2013-33172 displays a 3D side-by-side image on a TV screen, and the displayed side-by-side image is captured by an imaging unit of an HMD. Then, a controller of the HMD divides the captured image into a left image being a left half and a right image being a right half, and extracts corresponding feature points in the left image and the right image.

Further, the controller of the HMD adjusts relative positions of the left image and the right image in an up-and-down direction so that up-and-down positions of the feature points are horizontal. After that, the left image is displayed on a first display unit of the HMD, and the right image is displayed on a second display unit of the HMD.

In the configuration described in JP-A-2013-33172, display of adjustment objects that receive various operations of a user is not described.

For example, in a case where positions of the adjustment objects in the image displayed on the HMD are not appropriate, there is a problem in that operability of a user may be degraded.

### SUMMARY

According to one aspect that achieves the above-mentioned object, provided is a display system constituted by an information processing device and a display device connected to each other. The display device includes a first display unit configured to display an image, the first display unit being mounted on a head of a user, a reception unit configured to receive an image from the information processing device, and a first controller configured to divide the image at a set division position, generate two divided images, and cause the first display unit to display each of the divided images. The information processing device includes a transmission unit configured to transmit the image to the display device and a second controller configured to cause the image to include an adjustment object. The first display unit includes a right-eye display unit configured to emit imaging light to a right eye of the user and a left-eye display unit configured to emit imaging light to a left eye of the user. The first controller divides image data corresponding to the image received by the reception unit into two pieces to generate two pieces of divided image data, causes the right-eye display unit to display an image based on one piece of the divided image data, and causes the left-eye display unit to display an image based on the other piece of the divided image data. The second controller separates a position of the adjustment object away from a position corresponding to the division position.

The display system described above may adopt a configuration in which the information processing device includes a second display unit configured to display an image and the second controller causes the transmission unit to transmit, to the display device, the image to be displayed on the second display unit.

The display system described above may adopt a configuration in which the second controller of the information processing device displays the adjustment object in a right region of the image.

The display system described above may adopt a configuration in which the second controller of the information processing device displays the adjustment object in an upper right region of the image.

The display system described above may adopt a configuration in which the second controller of the information processing device displays the adjustment object so that the adjustment object does not overlap another adjustment object.

The display system described above may adopt a configuration in which the second controller of the information processing device displays the adjustment object to be vertically long.

The display system described above may adopt a configuration in which the second controller of the information processing device includes a reception unit configured to receive an input and the second controller of the information processing device displays the adjustment object when the reception unit receives an input, and does not display the adjustment object when the reception unit does not receive an input.

The display system described above may adopt a configuration in which the second controller of the information processing device includes a detection unit that detects that the display device is connected, and the second controller of the information processing device lowers luminance of the image displayed on the second display unit, in accordance with a detection result of the detection unit, to be lower than set luminance.

The display system described above may adopt a configuration in which the second controller of the information processing device superimposes an image with a predetermined density on the image and reduces luminance of the image to be displayed on the second display unit.

The display system described above may adopt a configuration in which the adjustment object includes a slide bar object and the slide bar object includes a slide bar image extending in a right-and-left direction of the image.

The display system described above may adopt a configuration in which the second controller of the information processing device displays an error image on the second display unit in accordance with occurrence of an error in the display device, the error image indicating the occurrence of the error.

According to another aspect that achieves the above-mentioned object, a control method of a display system constituted by an information processing device and a display device mounted on a head of a user connected to each other, includes an arranging step for, by the information processing device, separating a position of the adjustment object away from a position corresponding to a set division position when an adjustment object is included in an image, a transmitting step for transmitting the image to the display device by the information processing device, a receiving step for receiving the image by the display device, and a displaying step for, by the display device, dividing the image at the division position into two divided images and displaying each of the divided images, wherein in the displaying step, the display device divides image data corresponding to the image into two pieces to generate two pieces of divided image data, causes a right-eye display unit to display an image based on one piece of the divided image data, and causes a left-eye display unit to display an image based on the other piece of the divided image data.

According to further another aspect that achieves the above-mentioned object, an information processing device that is mounted on a head of a user, generates two divided images by dividing an image at a set division position, and is connected to a display device configured to display each of the divided images includes a transmission unit configured to transmit the image to the display device, and a display controller configured to cause the image to include an adjustment object and separate a position of the adjustment object away from a position corresponding to the division position.

According to further another aspect that achieves the above-mentioned object, a control program of an information processing device that is mounted on a head of a user, generates plural divided images by dividing an image at a set division position, is connected to a display device configured to display each of the divided images, and includes a computer, is configured to cause the computer to function as a transmission unit configured to transmit the image to the display device, and a display controller configured to cause the image to include an adjustment object, separate a position of the adjustment object away from a position corresponding to the division position that indicates a position at which the image is divided by the display device.

### BRIEF DESCRIPTION OF THE DRAWINGS

FIG. 1 is a diagram illustrating a configuration of a display system.

FIG. 2 is a diagram illustrating a configuration of an optical system of an image display unit.

FIG. 3 is a perspective view illustrating a configuration of a main part of the image display unit.

FIG. 4 is a diagram illustrating a configuration of components forming an HMD.

FIG. 5 is a diagram illustrating a configuration of a first controller of the HMD and a smartphone.

FIG. 6 is a diagram illustrating one example of images displayed by the smartphone and the HMD.

FIG. 7 is a diagram illustrating another example of images displayed by the smartphone and the HMD.

FIG. 8 is a diagram further illustrating another example of images displayed by the smartphone and the HMD.

FIG. 9 is a diagram further illustrating another example of an image displayed by the smartphone.

FIG. 10 is a flowchart illustrating processing of a second controller of the smartphone.

FIG. 11 is a flowchart illustrating processing of the second controller of the smartphone.

FIG. 12 is a flowchart illustrating first luminance adjustment processing of the second controller.

FIG. 13 is a flowchart illustrating processing of a first controller of the HMD.

### DESCRIPTION OF EXEMPLARY EMBODIMENTS

Now, with reference to the drawings, description is made on an exemplary embodiment.

### 1. Configuration of Display System

1-1. Overall Configuration of Display System

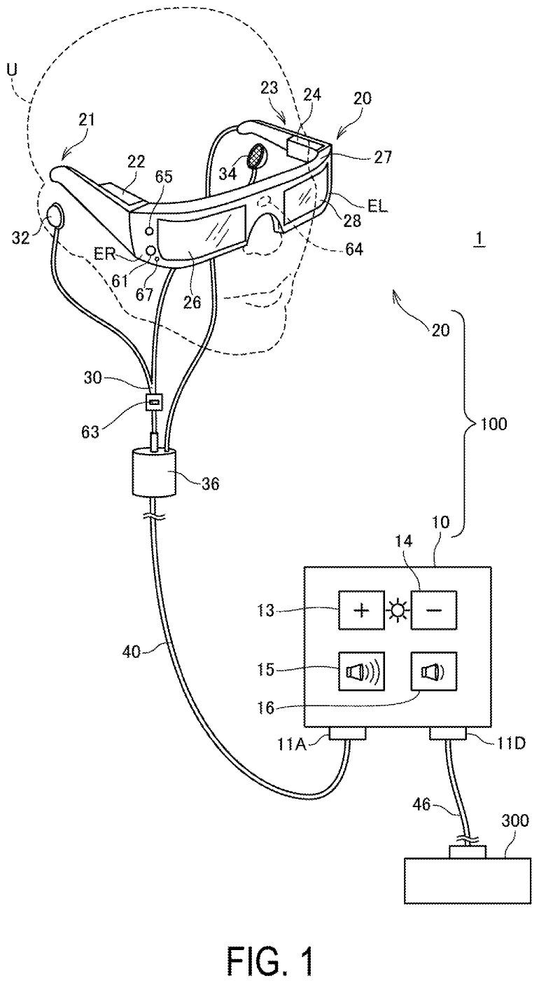

FIG. 1 is a diagram illustrating an overall configuration of a display system 1.

As illustrated in FIG. 1, the display system 1 includes a Head Mounted Display (HMD) 100. The HMD 100 is a device including an image display unit 20 mounted on a head of a user and a connection device 10, and is a device for causing a virtual image to be visually recognized by the user with the image display unit 20 while mounted on the head of the user. The HMD 100 corresponds to one example of a “display device”. In the following description, the user refers to a user who wears and uses the HMD 100.

The connection device 10 includes a connector 11A and a connector 11D in a box-shaped case. The image display unit 20 is connected to the connector 11A via a connection cable 40. Hereinafter, in a case where the connectors 11A and 11D are not distinguished, the connectors 11A and 11D are referred to as connectors 11. The case of the connection device 10 may be referred to as a housing or a main body.

The display system 1 is a system obtained by connecting a smartphone 300 to the HMD 100. The connector 11D is an interface to which the smartphone 300 of the HMD 100 is connected. That is, in the present exemplary embodiment, the smartphone 300 is connected to the connector 11D. The smartphone 300 corresponds to one example of an “information processing device”. Note that, the smartphone 300 is merely one example of an information processing device. For example, as an information processing device, a desktop-type personal computer, a notebook-type personal computer, a tablet-type personal computer, or the like may be connected to the connection device 10.

The connectors 11 are wired interfaces to be connected to a communication cable, and the connection device 10 is connected to an external device via the communication cable. The connector 11A includes a terminal that connects the connection cable 40 and an interface circuit that transmits and receives a signal via the connector 11A.

The connector 11A is provided to connect the image display unit 20 to the connection device 10. The connection cable 40 supplies power from the connection device 10 to the image display unit 20, and has a function of causing the image display unit 20 and the connection device 10 to transmit and receive data to and from each other.

The connector 11D is an interface to which image data are input from the smartphone 300, and is an interface capable of outputting sensor data to the smartphone 300. The smartphone 300 reproduces content data recorded in a non-volatile storage unit. For example, the connector 11D is a connector conforming to a known communication interface standard.

In the present exemplary embodiment, as one example, the connector 11D is an interface corresponding to input/output of image data and various types of data, and is connected to the smartphone 300 via a USB cable 46.

For example, a connector of a Universal Serial Bus (USB)-Type C standard may be adopted as the connector 11D. The interface corresponding to the USB-Type C is capable of transmitting data according to a USB 3.1 standard and supplying a direct current within 20 volts and 5 amperes. Further, as a function of an alternative mode of the USB-Type C, image data of a High Definition Multimedia Interface (HDMI) standard, image data of a Mobile High-definition Link (MHL) standard, and the like can be transmitted. The smartphone 300 is capable of performing power supply, transmission and reception of data, and supply of streaming data for images and audio via the USB cable 46. The alternative mode of the USB-Type C is known as Alternative Mode. HDMI is a registered trademark.

The image display unit 20 has an eyeglasses-like shape in the present exemplary embodiment. The image display unit 20 includes a main body including a right holding part 21, a left holding part 23, and a front frame 27. The main body further includes a right display unit 22, a left display unit 24, a right light-guiding plate 26, and a left light-guiding plate 28.

The image display unit 20 corresponds to one example of a “first display unit”. The right display unit 22 corresponds to one example of a “right-eye display unit”, and the left display unit 24 corresponds to one example of a “left-eye display unit”.

The right holding part 21 and the left holding part 23 extend rearward from both ends of the front frame 27, to hold the image display unit 20 on a head U of a user. One of the both ends of the front frame 27, which is positioned on the right side of the head U when the image display unit 20 is mounted, is referred to as an end ER, while the other one of the ends, which is positioned on the left side, is referred to as an end EL. The right holding part 21 extends from the end ER of the front frame 27 to a position corresponding to the right side of the head of the user in a state where the image display unit 20 is mounted. The left holding part 23 extends from the end EL to a position corresponding to the left side of the head of the user in a state where the image display unit 20 is mounted.

The right light-guiding plate 26 and the left light-guiding plate 28 are provided on the front frame 27. The right light-guiding plate 26 is positioned in front of the right eye of the user in a state where the image display unit 20 is mounted, and causes the user to visually recognize an image with the right eye. The left light-guiding plate 28 is positioned in front of the left eye of the user in a state where the image display unit 20 is mounted, and causes the user to visually recognize an image with the left eye.

The front frame 27 has a shape formed by coupling one end of the right light-guiding plate 26 and one end of the left light-guiding plate 28 to each other, and this coupling position corresponds to the middle of the forehead of the user in a state where the user wears the image display unit 20.

The front frame 27 may include a nose pad, which is brought into contact with a nose of the user in a state where the image display unit 20 is mounted, at the coupling position of the right light-guiding plate 26 and the left light-guiding plate 28. In this case, the image display unit 20 can be held to the head of the user by the nose pad, the right holding part 21, and the left holding part 23. Additionally, a belt, which is held into contact with a back of the head of the user when the image display unit 20 is mounted, may be coupled to the right holding part 21 and the left holding part 23, and in this case, the image display unit 20 can be held to the head U of the user by the belt.

Each of the right display unit 22 and the left display unit 24 is a module obtained by unitizing an optical unit and a peripheral circuit.

The right display unit 22 is a unit related to display of an image by the right light-guiding plate 26, and is provided on the right holding part 21 and is positioned in the vicinity of the right side of the head of the user in the mounted state. The left display unit 24 is a unit related to display of an image by the left light-guiding plate 28, and is provided on the left holding part 23 and is positioned in the vicinity of the left side of the head of the user in the mounted state. Note that, the right display unit 22 and the left display unit 24 may be collectively and simply referred to as a “display driving unit”.

The right light-guiding plate 26 and the left light-guiding plate 28 are optical parts formed of a light transmissive resin or the like, and guide imaging light output from the right display unit 22 and the left display unit 24 to the eyes of the user. The right light-guiding plate 26 and the left light-guiding plate 28 are, for example, prisms.

A dimmer plate may be provided on each of the surfaces of the right light-guiding plate 26 and the left light-guiding plate 28. The dimmer plate is an optical element being on a thin plate and having a different transmittance according to the wavelength range of light, and functions as a so-called wavelength filter. The dimmer plate is, for example, arranged so as to cover a front side of the front frame 27, which is a side opposite to the eyes of the user. By appropriately selecting optical properties of this dimmer plate, a transmittance of light in any wavelength range such as visible light, infrared light, and ultraviolet light can be adjusted, and a light amount of outside light entering the right light-guiding plate 26 and the left light-guiding plate 28 from an outside and passing through the right light-guiding plate 26 and the left light-guiding plate 28 can be adjusted.

Imaging light guided by the right light-guiding plate 26 and outside light passing through the right light-guiding plate 26 enter the right eye of the user. Similarly, the imaging light guided by the left light-guiding plate 28 and outside light passing through the left light-guiding plate 28 enter the left eye.

An illuminance sensor 65 is arranged on the front frame 27 of the image display unit 20. The illuminance sensor 65 receives outside light coming from the front side of the user U wearing the image display unit 20.

A camera 61 is provided on the front frame 27 of the image display unit 20. The camera 61 is provided at a position that the outside light passing through the right light-guiding plate 26 and the left light-guiding plate 28 is not blocked. In the example of FIG. 1, the camera 61 is arranged on a side of the end ER of the front frame 27, but may also be arranged on a side of the end EL, or may be arranged at the coupling portion of the right light-guiding plate 26 and the left light-guiding plate 28.

The camera 61 is a digital camera including an imaging element such as a CCD and a CMOS, an imaging lens, and the like, and the camera 61 in the present exemplary embodiment is a monocular camera, but may be formed by a stereo camera.

An LED indicator 67 is arranged on the front frame 27. The LED indicator 67 is arranged in the vicinity of the camera 61 at the end ER, and lights up during operation of the camera 61 to notify the capturing is in progress.

A distance sensor 64 is provided on the front frame 27. The distance sensor 64 detects a distance to a target object to be measured, which is positioned in a preset measurement direction. The distance sensor 64 may be a light reflecting type distance sensor including a light source such as an LED or a laser diode, and a light-receiving unit that receives the reflected light being the light, which is emitted by the light source and reflected by the target object to be measured, for example. Further, the distance sensor 64 may be an ultrasonic wave type distance sensor including a sound source that generates ultrasonic waves and a detector that receives the ultrasonic waves reflected by the target object to be measured. Further, the distance sensor 64 may be a laser range scanner, and in this case, a wider region including an area in front of the image display unit 20 can be scanned.

Each of the right display unit 22 and the left display unit 24 of the image display unit 20 is connected to the connection device 10. In the HMD 100, the connection cable 40 is connected to the left holding part 23, and a wiring line connected to this connection cable 40 is laid inside the image display unit 20 to connect each of the right display unit 22 and the left display unit 24 to the connection device 10.

The connection cable 40 includes an audio connector 36, wherein a headset 30 including a right earphone 32 and a left earphone 34 constituting a stereo headphone, and a microphone 63, is connected to the audio connector 36. The right earphone 32 is mounted on the right ear of the user and the left earphone 34 is mounted on the left ear of the user. The right earphone 32 and the left earphone 34 may also be referred to as sound output units.

The right earphone 32 and the left earphone 34 output a sound based on a sound signal output from the connection device 10.

The microphone 63 collects a sound and outputs the sound signal to the connection device 10. The microphone 63 may be, for example, a monaural microphone or a stereo microphone, or may be a directional microphone or a non-directional microphone.

The connection device 10 includes a luminance adjustment key 13, a luminance adjustment key 14, a sound volume adjustment key 15, and a sound volume adjustment key 16 as operated parts to be operated by the user. A hardware key constitutes each of the luminance adjustment key 13, the luminance adjustment key 14, the sound adjustment key 15, and the sound adjustment key 16. These operated parts are arranged on the surface of the main body of the connection device 10, and may be operated by fingers of the user, for example.

The luminance adjustment keys 13 and 14 are hardware keys for adjusting display luminance of the image displayed on the image display unit 20. The luminance adjustment key 13 instructs an increase in luminance, and the luminance adjustment key 14 instructs a reduction in luminance. The volume adjustment keys 15 and 16 are hardware keys for adjusting volume of the sound output from the right earphone 32 and the left earphone 34. The volume adjustment key 15 instructs an increase in sound volume, and the sound volume adjustment key 16 instructs a reduction in sound volume.

1-2. Configuration of Optical System of Image Display Unit

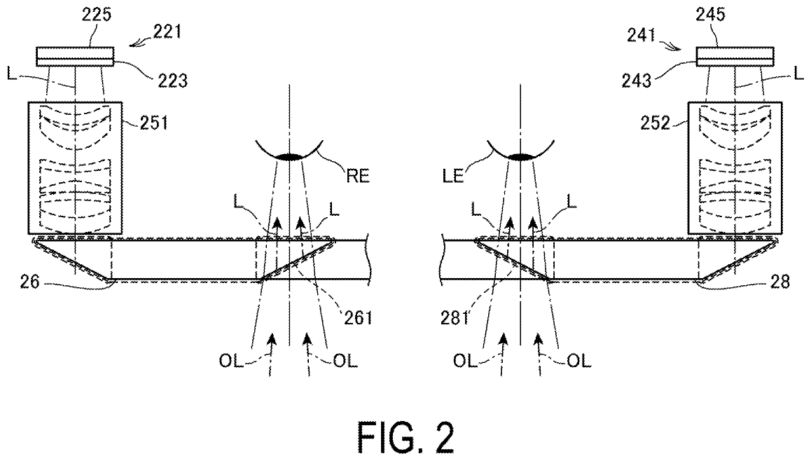

FIG. 2 is a plan view illustrating a main part of a configuration of an optical system of the image display unit 20. In FIG. 2, a left eye LE and a right eye RE of a user are illustrated for description.

As illustrated in FIG. 2, the right display unit 22 and the left display unit 24 are arranged symmetrically on the right-and-left sides. As a configuration in which the user is caused to visually recognize an image with the right eye RE, the right display unit 22 includes an Organic Light Emitting Diode (OLED) unit 221 that emits imaging light. Additionally, the right display unit 22 includes a right optical system 251 including a lens group that guides imaging light L emitted by the OLED unit 221. The imaging light L is guided by the right optical system 251 to the right light-guiding plate 26.

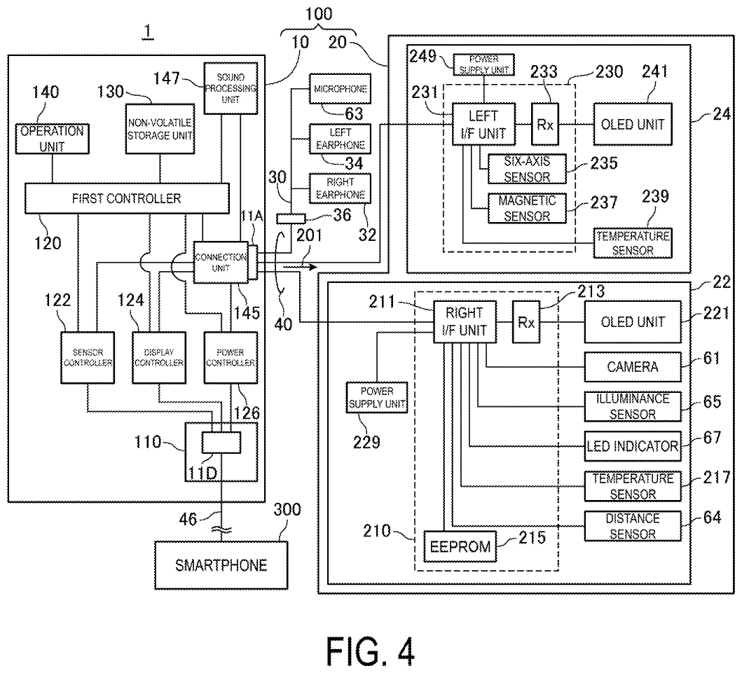

The OLED unit 221 includes an OLED panel 223 and an OLED drive circuit 225 that drives the OLED panel 223. The OLED panel 223 is a self-light emission type display panel including light-emitting elements arranged in a matrix, which emit light by organic electro-luminescence to emit red (R) color light, green (G) color light, and blue (B) color light, respectively. The OLED panel 223 has a plurality of pixels, each of which includes, as one pixel, a unit including one R element, one G element, and one B element, and forms an image with the plurality of pixels arranged in a matrix. The OLED drive circuit 225 is controlled by a first controller 120 so as to select the light-emitting elements of the OLED panel 223 and energize the light-emitting elements. In this manner, the light-emitting elements of the OLED panel 223 are caused to emit light. Description is made on the first controller 120 later with reference to FIG. 4.

The OLED drive circuit 225 is fixed by bonding or the like to a back surface of the OLED panel 223, that is, a back side of a light-emitting surface. The OLED drive circuit 225 may include, for example, a semiconductor device that drives the OLED panel 223, and may be mounted on a substrate (not illustrated) fixed to the back surface of the OLED panel 223. A temperature sensor 217 illustrated in FIG. 4 is mounted on this substrate.

Note that, the OLED panel 223 may adopt a configuration in which light-emitting elements that emit white color light are arranged in a matrix and color filters corresponding to the R color, the G color, and the B color respectively are arranged to be superimposed on the light-emitting elements. Additionally, the OLED panel 223 of a WRGB configuration including light-emitting elements that emit white (W) color light may be used, in addition to the light-emitting elements that emit the R color light, the G color light, and the B color light respectively.

The right optical system 251 includes a collimate lens that collimates the imaging light L emitted from the OLED panel 223. The imaging light L collimated by the collimate lens enters the right light-guiding plate 26. In an optical path that guides light inside the right light-guiding plate 26, a plurality of reflective surfaces that reflect the imaging light L are formed. The imaging light L is reflected a plurality of times inside the right light-guiding plate 26 and then, is guided to the right eye RE side. In the right light-guiding plate 26, a half mirror 261 (reflective surface) positioned in front of the right eye RE is formed. The imaging light L is reflected by the half mirror 261 to be emitted from the right light-guiding plate 26 toward the right eye RE, and this imaging light L forms an image on a retina of the right eye RE, and causes the user to visually recognize the image.

Additionally, as a configuration in which the user is caused to visually recognize an image with the left eye LE, the left display unit 24 includes an OLED unit 241 that emits imaging light, and a left optical system 252 including a lens group that guides the imaging light L emitted by the OLED unit 241, and the like. The imaging light L is guided by the left optical system 252 to the left light-guiding plate 28.

The OLED unit 241 includes an OLED panel 243, and an OLED drive circuit 245 that drives the OLED panel 243. The OLED panel 243 is a self-light emission type display panel configured similarly to the OLED panel 223. The OLED drive circuit 245 is instructed by the first controller 120 so as to select the light-emitting elements of the OLED panel 243 and energize the light-emitting elements. In this manner, the light-emitting elements of the OLED panel 243 are caused to emit light.

The OLED drive circuit 245 is fixed by bonding or the like to a back surface of the OLED panel 243, that is, a back side of a light-emitting surface. The OLED drive circuit 245 may include, for example, a semiconductor device that drives the OLED panel 243, and may be mounted on a substrate (not illustrated) fixed to the back surface of the OLED panel 243. A temperature sensor 239 illustrated in FIG. 4 is mounted on this substrate.

The left optical system 252 includes a collimate lens that collimates the imaging light L emitted from the OLED panel 243. The imaging light L collimated by the collimate lens enters the left light-guiding plate 28. The left light-guiding plate 28 is an optical element in which a plurality of reflective surfaces that reflect the imaging light L are formed, and the left light-guiding plate 28 is, for example, a prism. The imaging light L is reflected a plurality of times inside the left light-guiding plate 28 and then, is guided to the left eye LE side. In the left light-guiding plate 28, a half mirror 281 (reflective surface) positioned in front of the left eye LE is formed. The imaging light L is reflected by the half mirror 281 to be emitted from the left light-guiding plate 28 to the left eye LE, and this imaging light L forms an image on a retina of the left eye LE, and causes the user to visually recognize the image.

According to the configuration, the HMD 100 functions as a transmissive display device. Namely, the imaging light L reflected by the half mirror 261 and outside light OL passing through the right light-guiding plate 26 enter the right eye RE of the user. Additionally, the imaging light L reflected by the half mirror 281 and the outside light OL passing through the half mirror 281 enter the left eye LE. Accordingly, the HMD 100 superimposes the imaging light L of an image processed internally and the outside light OL on each other, and causes the imaging light L and the outside light OL superimposed on each other to enter the eyes of the user, and the user views an outside scene through the right light-guiding plate 26 and the left light-guiding plate 28, and visually recognizes the image formed by the imaging light L and superimposed on this outside scene.

The half mirrors 261 and 281 are image extracting units that reflect the imaging light output from the right display unit 22 and the left display unit 24 respectively and extract images, and may be referred to as display units.

Note that, the left optical system 252 and the left light-guiding plate 28 are collectively referred to as a “left light-guiding unit”, and the right optical system 251 and the right light-guiding plate 26 are collectively referred to as a “right light-guiding unit”. Configurations of the right light-guiding unit and the left light-guiding unit are not limited to the example described above, and may use any manner as long as imaging light is used to form a virtual image in front of the eyes of the user. For example, a diffraction grating may be used, or a semi-transmissive reflection film may be used.

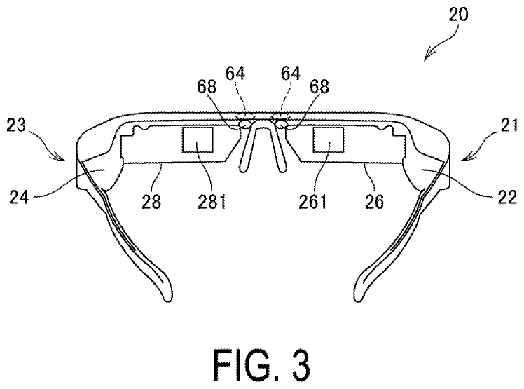

FIG. 3 is a diagram illustrating a configuration of a main part of the image display unit 20. FIG. 3 is a perspective view of the main part of the image display unit 20 seen from a head side of the user. Note that, in FIG. 3, illustration of the connection cable 40 is omitted.

FIG. 3 illustrates a side held in contact with the head of the user of the image display unit 20, that is, a side seen from the right eye RE and the left eye LE of the user. In other words, in FIG. 3, back sides of the right light-guiding plate 26 and the left light-guiding plate 28 are viewed.

In FIG. 3, the half mirror 261 that irradiates the right eye RE of the user with imaging light and the half mirror 281 that irradiates the left eye LE with imaging light are visible as approximately square-shaped regions. Additionally, as described above, outside light passes through all the right light-guiding plate 26 including the half mirror 261 and all the left light-guiding plate 28 including the half mirror 281. Thus, the user visually recognizes an outside scene through all the right light-guiding plate 26 and the left light-guiding plate 28, and visually recognizes rectangular display images at positions of the half mirrors 261 and 281.

Additionally, in general, a visual field angle of a human is approximately 200 degrees in the horizontal direction and approximately 125 degrees in the vertical direction, and an effective field of view excellent in information acceptance performance of the visual field angle of a human is approximately 30 degrees in the horizontal direction and approximately 20 degrees in the vertical direction. Further, a stable field of fixation in which a point of fixation at which a human fixates is promptly and stably visible ranges from approximately 60 degrees to 90 degrees in the horizontal direction, and ranges from approximately 45 degrees to 70 degrees in the vertical direction.

Further, an actual visual field which the user visually recognizes through the image display unit 20, and through the right light-guiding plate 26 and the left light-guiding plate 28 may be referred to as an actual Field Of View (FOV). In the configuration of the exemplary embodiment illustrated in FIG. 3, the actual field of view corresponds to the actual visual field visually recognized by the user through the right light-guiding plate 26 and the left light-guiding plate 28. The actual field of view is narrower than the visual field angle and the stable field of fixation, but wider than the effective field of view.

Further, inner cameras 68 are arranged on the user side of the image display unit 20. A pair of inner cameras 68 are provided in a central position between the right light-guiding plate 26 and the left light-guiding plate 28 so as to correspond respectively to the right eye RE and the left eye LE of the user. The inner cameras 68 are a pair of cameras that respectively capture an image of the right eye RE and the left eye LE of the user. The inner cameras 68 are instructed by the first controller 120 so as to capture an image. The first controller 120 analyzes the captured image data of the inner cameras 68. For example, the first controller 120 detects an image of the reflected light and the pupil on the surface of the eyeball of each of the right eye RE and the left eye LE from the imaging data of the inner camera 68, and determines the sight line direction of the user. Further, the first controller 120 may determine the change in the sight line direction of the user, and may detect the eyeball movement of each of the right eye RE and the left eye LE.

Here, the movement of the user's sight line may also be regarded as movement of the user's virtual viewpoint.

Further, the first controller 120 may extract an image of an eyelid of each of the right eye RE and the left eye LE of the user from the captured image data of the inner camera 68 to detect the eyelid movement or may detect the eyelid state. In the present exemplary embodiment, the image display unit 20 includes a pair of inner cameras 68 and 68, but for example, one inner camera 68 may be provided at the central position of the image display unit 20. In this case, it is preferred that one inner camera 68 have an angle of view that allows the right eye RE and the left eye LE to be captured, but for example, only one of the right eye RE and the left eye LE may be captured by the inner camera 68. That is, the first controller 120 may detect the sight line direction, eye movement, eyelid movement, eyelid state, and the like of either one of the right eye RE or the left eye LE.

When detecting the sight line direction of the right eye RE and the left eye LE from the captured image of the inner camera(s) 68, the first controller 120 can determine the convergence angle of the right eye RE and the left eye LE. The convergence angle corresponds to a distance to an object that the user fixates on. That is, when the user sterically views an image and an object, the convergence angle of the right eye RE and the left eye LE is determined in accordance with the distance to the object to be visually recognized. Accordingly, a distance from an object that the user fixates on can be obtained by detecting the convergence angle. Further, when an image is displayed so as to guide the convergence angle of the user, a stereoscopic view can be induced.

1-3. Configuration of Components of HMD

FIG. 4 is a diagram illustrating a configuration of components forming the HMD 100.

The right display unit 22 of the image display unit 20 includes a right display unit substrate 210. On the right display unit substrate 210, a right I/F (interface) unit 211 connected to the connection cable 40, a reception unit 213 that receives data input from the connection device 10 via the right I/F unit 211, and an EEPROM 215 are mounted. The right I/F unit 211 connects the reception unit 213, the EEPROM 215, the temperature sensor 217, the camera 61, the distance sensor 64, the illuminance sensor 65, and the LED indicator 67 to the connection device 10. The reception unit 213 connects the OLED unit 221 to the connection device 10.

The left display unit 24 includes a left display unit substrate 230. On the left display unit substrate 230, a left I/F unit 231 connected to the connection cable 40, a reception unit 233 that receives data input from the connection device 10 via the left I/F unit 231 are mounted. Further, the left display unit substrate 230 is mounted with a six-axis sensor 235 and a magnetic sensor 237.

The left I/F unit 231 connects the reception unit 233, the six-axis sensor 235, the magnetic sensor 237, and the temperature sensor 239 to the connection device 10. The reception unit 233 connects the OLED unit 241 to the connection device 10.

I/F is an abbreviation for interface. EEPROM is an abbreviation for Electrically Erasable Programmable Read-Only Memory. OLED is an abbreviation for Organic Light Emitting Diode. Note that, in the present exemplary embodiment, the reception unit 213 and the reception unit 233 are referred to as Rx213 and Rx233, respectively, in some cases.

The EEPROM 215 stores various types of data in a non-volatile manner. The EEPROM 215 stores, for example, data on light-emitting properties and display properties of the OLED units 221 and 241 of the image display unit 20, and data on properties of sensors of the right display unit 22 and the left display unit 24.

Specifically, the EEPROM 215 stores parameters regarding gamma correction of the OLED units 221 and 241, data used to compensate for detection values of the temperature sensors 217 and 239, and the like. These kinds of data are generated by inspection at the time of factory shipment of the HMD 100, and are written into the EEPROM 215. The data stored in the EEPROM 215 can be read by the first controller 120.

The camera 61 captures an image in accordance with a signal input via the right I/F unit 211 and outputs captured image data to the right I/F unit 211. The illuminance sensor 65 receives the outside light and outputs a detection value corresponding to an amount of the received light or an intensity of the received light. The LED indicator 67 lights up in accordance with a control signal or a driving current input via the right I/F unit 211.

The temperature sensor 217 detects a temperature of the OLED unit 221, and outputs a voltage value or a resistance value corresponding to the detected temperature as a detection value.

The distance sensor 64 executes distance detection, and outputs a signal indicating detection results to the connection device 10 via the right I/F unit 211. As the distance sensor 64, for example, an infrared ray type depth sensor, an ultrasonic type distance sensor, a Time Of Flight distance sensor, a distance detecting unit that combines image detection and sound detection, or the like can be used. Additionally, the distance sensor 64 may adopt a configuration in which an image obtained by stereo photographing by a stereo camera or a monocular camera is processed to detect a distance.

The reception unit 213 receives image data for displaying, which are transmitted from the connection device 10 via the right I/F unit 211, and outputs the image data to the OLED unit 221. The OLED unit 221 displays an image based on the image data transmitted from the connection device 10.

Further, the reception unit 233 receives image data for displaying, which are transmitted from the connection device 10 via the left I/F unit 231, and outputs the image data to the OLED unit 241. The OLED units 221 and 241 display an image based on the image data transmitted from the connection device 10.

The six-axis sensor 235 is a motion sensor including a three-axis acceleration sensor and a three-axis gyro sensor. The six-axis sensor 235 may adopt an IMU in which the sensors described above are provided as modules. The magnetic sensor 237 is a three-axis geomagnetic sensor, for example. The gyro sensor is also referred to as an angular velocity sensor. IMU is an abbreviation for Inertial Measurement Unit.

The temperature sensor 239 detects a temperature of the OLED unit 241, and outputs a voltage value or a resistance value corresponding to the detected temperature as a detection value.

The components of the image display unit 20 are operated with power supplied from the connection device 10 via the connection cable 40.

The image display unit 20 includes a power supply unit 229 on the right display unit 22, and a power supply unit 249 on the left display unit 24. The power supply unit 229 distributes and supplies the power supplied by the connection device 10 via the connection cable 40 to the components of the right display unit 22 including the right display unit substrate 210. Similarly, the power supply unit 249 distributes and supplies the power supplied by the connection device 10 via the connection cable 40 to the components of the left display unit 24 including the left display unit substrate 230. The right display unit 22 and the left display unit 24 may include a conversion circuit or the like that converts a voltage.

The connection device 10 includes an I/F unit 110, the first controller 120, a sensor controller 122, a display controller 124, a power controller 126, a non-volatile storage unit 130, an operation unit 140, a connection unit 145, and a sound processing unit 147.

The I/F unit 110 includes the connector 11D. Further, the I/F unit 110 includes an interface circuit, which is connected to the connector 11D and executes a communication protocol conforming to various communication standards.

The I/F unit 110 may be, for example, an interface substrate on which the connector 11D and the interface circuit are mounted. Further, a configuration may be adopted in which the first controller 120, the sensor controller 122, the display controller 124, and the power controller 126 of the connection device 10 are mounted on a connection device main substrate (not illustrated). In this case, on the connection device main substrate, the connector 11D of the I/F unit 110 and the interface circuit may be mounted.

Additionally, the I/F unit 110 may include, for example, an interface for a memory card capable of being connected to an external storage device or storage medium, or the I/F unit 110 may be constituted by a wireless communication interface.

The first controller 120 controls the components of the connection device 10. The first controller 120 includes a processor such as a CPU. CPU is an abbreviation for Central Processing Unit. The first controller 120 causes the processor to execute a program so as to control the components of the HMD 100 in cooperation of software and hardware. The processor corresponds to one example of a “computer”. The first controller 120 is connected to the non-volatile storage unit 130, the operation unit 140, the connection unit 145, and the sound processing unit 147.

The sensor controller 122 controls the camera 61, the distance sensor 64, the illuminance sensor 65, the temperature sensor 217, the six-axis sensor 235, the magnetic sensor 237, and the temperature sensor 239. Specifically, the sensor controller 122 is controlled by the first controller 120 so as to perform setting and initialization of a sampling period of each sensor and to execute energization to each sensor, transmission of control data, acquisition of detection values and the like, in correspondence to the sampling period of each sensor.

The sensor controller 122 is connected to the connector 11D of the I/F unit 110, and outputs the data relating to the detection values acquired from the sensors to the connector 11D at a preset timing. The smartphone 300 connected to the connector 11D can acquire the detection values of the sensors of the HMD 100 and the captured image data of the camera 61. In the present exemplary embodiment, the detection values of the sensors and the captured image data of the camera 61 are output to the smartphone 300 by the sensor controller 122.

The data output from the sensor controller 122 may be digital data including the detection values. Further, the sensor controller 122 may output data of results obtained by arithmetic processing based on the detection values of the sensors. For example, the sensor controller 122 integrally processes detection values of a plurality of sensors, and functions as a so-called sensor fusion processing unit. The sensor controller 122 executes sensor fusion so as to output data determined from the detection values of the sensors, for example, track data of movement of the image display unit 20 and relative coordinate data of the image display unit 20. The sensor controller 122 may have a function of transmitting/receiving various kinds of control data relating to transmission/reception of data to/from the smartphone 300 connected to the connector 11D.

The display controller 124 executes various kinds of processing for causing the image display unit 20 to display the image data input to the I/F unit 110 or an image based on the image data. In the present exemplary embodiment, an image signal output from the smartphone 300 is input to the connector 11D. The image signal is digital image data, but may be analog image data.

For example, the display controller 124 executes various kinds of processing such as cutting out of a frame, resolution conversion, intermediate frame generation, and frame rate conversion. Resolution conversion includes so-called scaling. The display controller 124 outputs image data corresponding to each of the OLED unit 221 and the OLED unit 241 to the connection unit 145. The image data input to the connection unit 145 are transmitted as an image signal 201 from the connector 11A to the right I/F unit 211 and the left I/F unit 231. The image signal 201 is digital image data processed in accordance with each of the OLED unit 221 and the OLED unit 241.

For example, when the image data input to the I/F unit 110 is 3D image data, the display controller 124 executes 3D image decode. The 3D image includes a broad stereoscopic image. In processing of the 3D image decode, the display controller 124 generates a frame for the right eye and a frame for the left eye from the 3D image data. A format of the 3D image data input to the I/F unit 110 is, for example, a side-by-side format.

In the present exemplary embodiment, the connector 11D is constituted by a USB-Type C connector. The display controller 124 receives image data transmitted in a USB-Type C alternative mode via the connector 11D.

Here, a device that outputs, to the connection device 10, an image signal displayed on the image display unit 20 or an image signal displayed on the image display unit 20 is referred to as an image source. In the present exemplary embodiment, the smartphone 300 outputs an image signal to the connection device 10, and hence the smartphone 300 is referred to as an image source.

The sensor controller 122 and/or the display controller 124 may be realized by cooperation of software and hardware by a processor executing a program. That is, the sensor controller 122 and the display controller 124 are constituted by a processor, and perform the operations described above by executing a program. In this example, the sensor controller 122 and the display controller 124 may be realized by a processor constituting the first controller 120 executing a program. In other words, the processor may function as the first controller 120, the display controller 124 and the sensor controller 122 by executing the program. Here, the processor can be paraphrased as a computer.

Further, the display controller 124 and the sensor controller 122 may include programmed hardware such as DSP and FPGA. Further, the sensor controller 122 and the display controller 124 may be integrated to constitute an SoC-FPGA. DSP is an abbreviation for Digital Signal Processor, FPGA is an abbreviation for Field Programmable Gate Array, and SoC is an abbreviation for System-on-a-Chip.

The power controller 126 is connected to the connector 11D. With power supplied from the connector 11D, the power controller 126 supplies power to the components of the connection device 10 and to the image display unit 20. Additionally, the power controller 126 may include a voltage conversion circuit (not illustrated), and may adopt a configuration in which a voltage is converted so as to be supplied to the components of the connection device 10 and to the image display unit 20. The power controller 126 may be constituted of a programmed semiconductor device such as a logic circuit and the FPGA. Further, the power controller 126 may be constituted of hardware common to the sensor controller 122 and/or the display controller 124.

Each of the sensor controller 122, the display controller 124, and the power controller 126 may include a work memory for executing data processing, and may execute processing by using a memory of the first controller 120.

The operation unit 140 detects an operation on an operated part of the connection device 10, and outputs, to the first controller 120, data indicating an operation content or an operation signal indicating the operated part.

The sound processing unit 147 generates a sound signal according to sound data that is input from the first controller 120, and outputs the sound signal to the connection unit 145. This sound signal is output from the connection unit 145 to the right earphone 32 and the left earphone 34 via the audio connector 36. Additionally, the sound processing unit 147 is controlled by the first controller 120 so as to adjust the volume of the sound signal. Additionally, the sound processing unit 147 generates sound data of the sound collected by the microphone 63, and outputs the sound data to the first controller 120. This sound data may be processed by the first controller 120 in the same manner as the detected values of the sensors of the image display unit 20.

Additionally, the connection device 10 may include a battery (not illustrated), and may adopt a configuration in which this battery supplies power to the components of the connection device 10 and the image display unit 20. The battery of the connection device 10 may be a rechargeable secondary battery.

1-4. Configuration of Smartphone

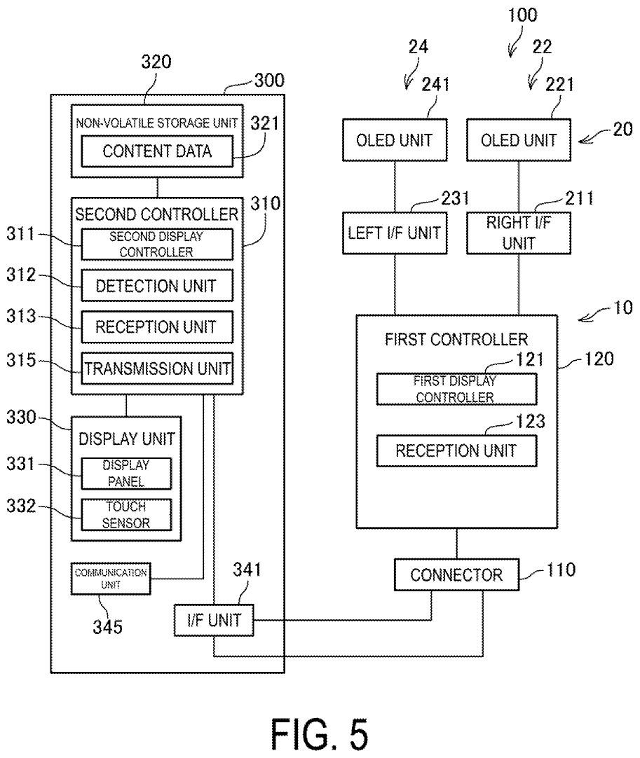

FIG. 5 is a diagram illustrating a configuration of the first controller 120 of the HMD 100 and the smartphone 300.

The smartphone 300 includes a second controller 310, a non-volatile storage unit 320, a display unit 330, an I/F unit 341, and a communication unit 345.

The second controller 310 includes a processor such as a CPU or a microcomputer, and this processor executes a program so as to control the components of the smartphone 300. The second controller 310 may include a ROM that stores, in a non-volatile manner, a control program to be executed by the processor, and a RAM that constitutes a work area of the processor. The processor corresponds to one example of a so-called “computer”. ROM is an abbreviation for Read Only Memory, and RAM is an abbreviation for Random Access Memory.

The non-volatile storage unit 320 stores, in a non-volatile manner, a program to be executed by the second controller 310 and data to be processed by the second controller 310. The non-volatile storage 320 is, for example, a magnetic recording device such as an HDD, or is a storage device using a semiconductor storage element such as a flash memory. HDD is an abbreviation for Hard Disk Drive.

The non-volatile storage unit 320 stores, for example, content data 321 of contents including an image. The content data 321 is a file in a format that the second controller 310 can process, and includes image data, and may include audio data.

Additionally, the non-volatile storage unit 320 stores an operating system (OS) as a basic control program executed by the second controller 310, an application program operated by using the OS as a platform, and the like. Additionally, the non-volatile storage unit 320 stores data processed during execution of the application program and data of processing results. OS is an abbreviation for Operating System.

A display panel 331 and a touch sensor 332 of the display unit 330 are connected to the second controller 310. Various images are displayed on the display panel 331 based on control of the second controller 310. the display panel 331 is formed of, for example, a Liquid Crystal Display (LCD). The display panel 331 corresponds to one example of a “second display unit”.

The touch sensor 332 detects a touch operation, and outputs data indicating the detected operation to the second controller 310. The data output from the touch sensor 332 are coordinate data indicating an operating position in the touch sensor 332, or the like.

The I/F unit 341 is an interface connected to an external device, and corresponds to the output unit in the present disclosure. The I/F unit 341 executes communication conforming to, for example, a standard such as an HDMI interface and a USB interface. The I/F unit 341 includes a connector to be connected to the USB cable 46, and an interface circuit that processes a signal transmitted via the connector. The I/F unit 341 is an interface substrate including the connector and the interface circuit, and is connected to a main substrate on which a processor and the like of the second controller 310 are mounted. Alternatively, the connector and the interface circuit constituting the I/F unit 341 are mounted on a main substrate of the smartphone 300.

In the present exemplary embodiment, the I/F unit 341 includes a USB interface, and is connected to the connector 11D via the USB cable 46. For example, the second controller 310 outputs image data via the USB cable 46, and receives data indicating output values of the sensors from the connection device 10.

Additionally, the I/F unit 341 may be a wireless communication interface. In this case, the I/F unit 341 may be an interface substrate on which a communication circuit including an RF unit is mounted, or may be a circuit mounted on a main substrate.

The communication unit 345 is a communication interface that executes data communication with an external device. The communication unit 345 may be a wired communication interface capable of being connected to a cable, or may be a wireless communication interface. For example, the communication unit 345 may be a wired LAN interface supporting Ethernet (trade name), or a wireless LAN interface supporting IEEE802.11 standards.

Further, the communication unit 345 is, for example, a communication interface connected to another smartphone via a radio telephone network.

The second controller 310 includes a second display controller 311, a detection unit 312, a reception unit 313, and a transmission unit 315. Specifically, the second controller 310 functions as the second display controller 311, the detection unit 312, the reception unit 313, and the transmission unit 315 by the processor of the second controller 310, which executes a control program.

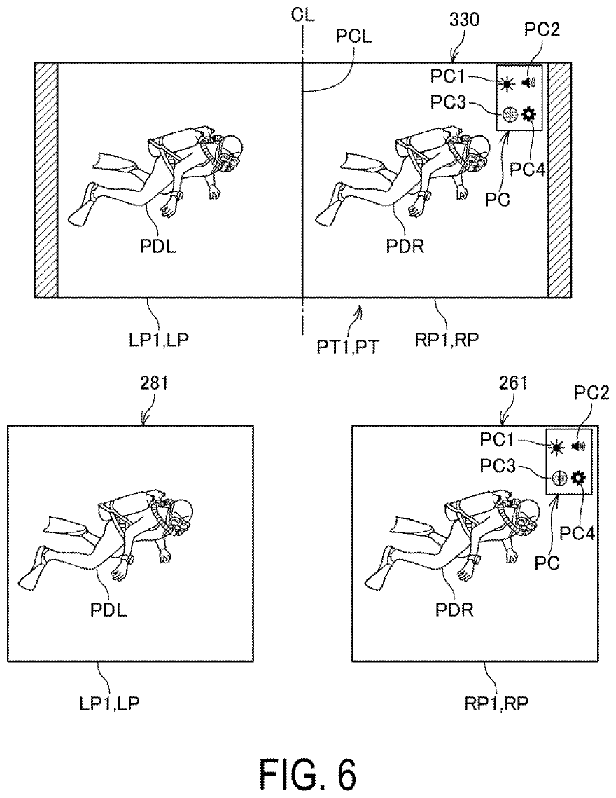

The second display controller 311 reproduces the content data 321, and displays an image corresponding to the image data contained in the content data 321 on the display panel 331 of the display unit 330. Description is made on the image later with reference to FIG. 6 to FIG. 8.

Further, the second display controller 311 displays an operation menu image on the display panel 331 of the display unit 330. The operation menu image is displayed in a case where a user adjusts luminance and the like of the image. Specifically, the second display controller 311 separates a position of the operation menu image away from a position corresponding to a division position. The operation menu image corresponds to one example of an “adjustment object”. The division position is positioned on a boundary between a right image and a left image. The right image corresponds to an image displayed on the right display unit 22 of the HMD 100. The left image corresponds to an image displayed on the left display unit 24 of the HMD 100. Description is made on the operation menu image, the division position, the right image, and the left image later with reference to FIG. 6 to FIG. 8.

Further, in accordance with the detection result of the detection unit 312, the second display controller 311 lowers luminance of the image displayed on the display unit 330 to be lower than set luminance. Specifically, in a case where the detection unit 312 detects that the HMD 100 is connected, the second display controller 311 reduces the luminance of the image displayed on the display unit 330 to be lower than the set luminance. In the following description, the “set luminance” is referred to as “luminance in a normal state” in some cases.

To be more specific, the second display controller 311 reduces the luminance of the image displayed on the display unit 330 by superimposing an image with a predetermined density on the image. In the following description, the “image with a predetermined density” is referred to as a “dark image” in some cases. Specifically, the “dark image” is a gray image with a predetermined density. That is, the second display controller 311 reduces the luminance of the image displayed on the display unit 330 by superimposing, on an upper layer of the image displayed on the display unit 330, a layer on which the dark image is formed.

The detection unit 312 detects that the HMD 100 is connected. Specifically, the detection unit 312 detects that the HMD 100 is connected by detecting that the connector 11D of the HMD 100 is connected to the connector of the I/F unit 341.

The reception unit 313 receives an input by a user. Specifically, the reception unit 313 receives an operation input by the user via the touch sensor 332 of the display unit 330.

The transmission unit 315 transmits, to the HMD 100, the image data corresponding to the image displayed by the second display controller 311 on the display panel 331 of the display unit 330.

The image data output from the smartphone 300 to the connection device 10 may contain, in addition to the image data obtained by reproducing the content data 321, image data corresponding to an image displayed by the smartphone 300 on the display panel 331 of the display unit 330. In this case, the HMD 100 displays the same image as that on the display panel 331, and performs so-called “mirroring display”.

1-5. Configuration of First Controller of HMD

The first controller 120 of the HMD 100 includes a first display controller 121 and a reception unit 123. Specifically, the first controller 120 functions as the first display controller 121 and the reception unit 123 by the processor of the first controller 120, which executes a control program.

The reception unit 123 receives an image from the smartphone 300. Specifically, the reception unit 123 receives the image transmitted from the transmission unit 315 of the smartphone 300. That is, the reception unit 123 receives the image corresponding to the image data contained in the content data 321. In other words, the reception unit 123 receives the image displayed on the display unit 330.

The first display controller 121 obtains a plurality of divided images by dividing the image, which is received by the reception unit 123, at the set division position. Additionally, the first display controller 121 causes the image display unit 20 to display the respective divided images.

Specifically, the first display controller 121 generates the right image and the left image by dividing the image, which is received by the reception unit 123, at the division position. The right image and the left image correspond to examples of the “divided images”. Additionally, the first display controller 121 causes the right display unit 22 to display the right image, and causes the left display unit 24 to display the left image.

To be more specific, the first display controller 121 transmits the right image to the OLED unit 221 via the right I/F unit 211, and causes the OLED unit 221 to display the right image. Further, the first display controller 121 transmits the left image to the OLED unit 241 via the left I/F 231, and causes the OLED unit 241 to display the left image.

### 2. Description of Processing of Controller in Specific Examples

FIG. 6 to FIG. 8 are diagrams illustrating an image PT displayed on the display panel 331 of the display unit 330 of the smartphone 300, a right image RP displayed on the right display unit 22 of the HMD 100, and a left image LP displayed on the left display unit 24 of the HMD 100, respectively.

In each of FIG. 6 to FIG. 8, one example of the image PT is illustrated in an upper part, one example of the right image RP is illustrated in a lower right part, and one example of the left image LP is illustrated in a lower left part.

Note that, in FIG. 6 to FIG. 8, description is made on a case where the image received by the reception unit 123 is set to be divided by the first display controller 121 at the division position.

FIG. 6 is a diagram illustrating one example of the images displayed by the smartphone 300 and the HMD 100. In FIG. 6, an image PT1 displayed on the display unit 330 of the smartphone 300, a right image RP1 displayed on the right display unit 22 of the HMD 100, and a left image LP1 displayed on the left display unit 24 of the HMD 100 are illustrated.

The image PT1 is an image corresponding to 3D image data in a side-by-side format. The image PT1 includes the right image RP1, the left image LP1, and a boundary line image PCL. The right image RP1 includes an operation menu image PC. The image PT1 is displayed by the second display controller 311 on the display unit 330.

The second display controller 311 displays the operation menu image PC in an upper right region of the image PT1. Further, the second display controller 311 displays the operation menu image PC to be vertically long. That is, the second display controller 311 displays the operation menu image PC so that a size of the operation menu image PC in an up-and-down direction is larger than a size of the operation menu image PC in a right-and-left direction. The operation menu image PC corresponds to one example of an “adjustment object”.

Specifically, in a case where the reception unit 313 receives an operation input of a user via the touch sensor 332, the second display controller 311 displays the operation menu image PC on the display unit 330. The operation input of the user is, for example, a tap operation on the display unit 330.

In a case where the reception unit 313 does not receive an input operation of a user via the touch sensor 332, the second display controller 311 does not display the operation menu image PC on the display unit 330. For example, in a case where the reception unit 313 does not successively receive an operation input of a user for a second predetermined time or more from a time point at which the reception unit 313 receives an operation input of a user, the second display controller 311 hides the operation menu image PC displayed on the display unit 330. The second predetermined time is, for example, thirty seconds.

The operation menu image PC includes a luminance adjustment icon PC1, a sound volume adjustment icon PC2, a division adjustment icon PC3, and an adjustment icon PC4 for other conditions. A user taps the luminance adjustment icon PC1 so as to adjust luminance of the image PT1. When the luminance adjustment icon PC1 is tapped, for example, a slide bar for adjusting luminance is displayed. The user is allowed to adjust luminance by sliding a knob of the slide bar.

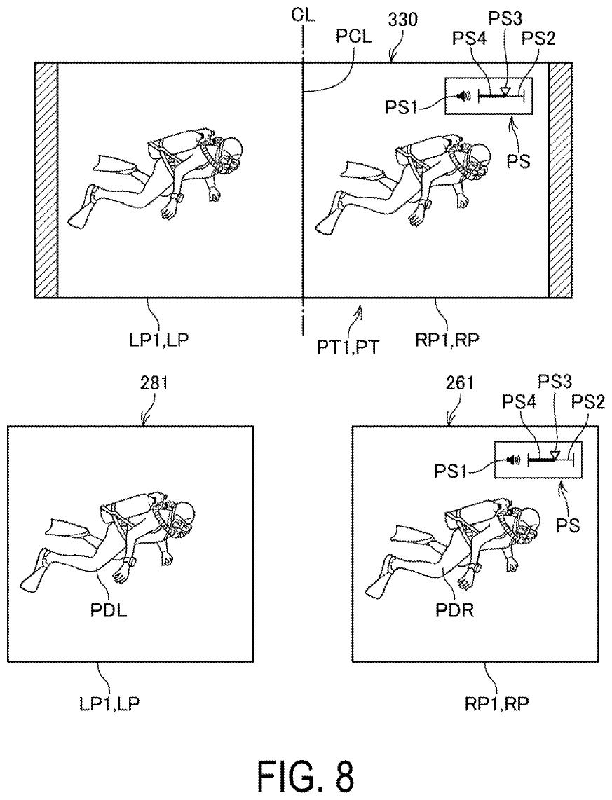

A user taps the sound volume adjustment icon PC2 so as to adjust sound volume output from the right earphone 32 and the left earphone 34. When the sound volume adjustment icon PC2 is tapped, for example, a slide bar for adjusting sound volume is displayed. Description is made on the slide bar for adjusting sound volume later with reference to FIG. 8.

A user taps the division adjustment icon PC3 so as to switch whether the first display controller 121 divides the image PT received by the reception unit 123.

Specifically, in a case where the division adjustment icon PC3 is tapped under a state in which the first display controller 121 is set to divide the image PT, the second controller 310 switches to a setting that the first display controller 121 does not divide the image PT. In a case where the division adjustment icon PC3 is tapped under a state in which the first display controller 121 is set not to divide the image PT, the second controller 310 switches to a setting that the first display controller 121 divides the image PT.

In the setting that the first display controller 121 divides the image, the first display controller 121 generates the right image RP and the left image LP by dividing the image PT, which is received by the reception unit 123, at the set division position. Additionally, the first display controller 121 causes the right display unit 22 to display the right image RP, and causes the left display unit 24 to display the left image LP.

Note that, in the setting that the first display controller 121 does not divide the image PT, the first display controller 121 causes each of the right display unit 22 and the left display unit 24 to display the image PT received by the reception unit 123.

A user taps the adjustment icon PC4 for other conditions so as to adjust other conditions. The adjustment for other conditions indicates adjustment for conditions other than the adjustment of luminance of the image PT1, the adjustment of sound volume, and the adjustment of the settings whether or not to divide the image PT. The adjustment for other conditions includes, for example, adjustment of coloration of the image PT1. When the adjustment icon PC4 for other conditions is tapped, the second display controller 311 displays, on the display unit 330, an image subjected to the adjustment for other conditions.

The right image RP1 includes an image PDR indicating a diver. The left image LP1 includes an image PDL indicating a diver. The image PDR and the image PDL are formed so that a user views the diver three-dimensionally when the right image RP1 is displayed on the right display unit 22 of the HMD 100, and the left image LP1 is displayed on the left display unit 24 of the HMD 100. In other words, the image PT1 is an image corresponding to 3D image data in a side-by-side format. Thus, when the right image RP1 is displayed on the right display unit 22 of the HMD 100, and the left image LP1 is displayed on the left display unit 24 of the HMD 100, the user can view the diver three-dimensionally.

The boundary line image PCL is arranged at a position of a center line CL in the image PT1. The position of the boundary line image PCL corresponds to one example of the “set division position”. The center line CL indicates a center position of the image PT1 in the right-and-left direction.

The first display controller 121 of the first controller 120 of the HMD 100 generates the right image RP1 and the left image LP1 by dividing the image PT1 at the position of the boundary line image PCL. Additionally, the first display controller 121 causes the right display unit 22 to display the right image RP1, and causes the left display unit 24 to display the left image LP1.

Further, the right image RP1 includes the operation menu image PC, and the right image RP1 is displayed by the first display controller 121 on the right display unit 22. Therefore, a user is allowed to visually recognize the operation menu image PC with the right eye.

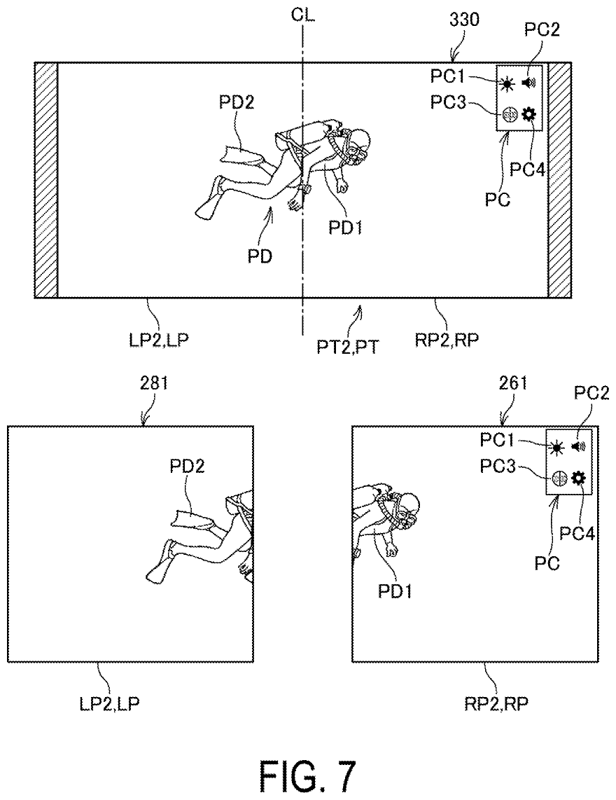

FIG. 7 is a diagram illustrating another example of images displayed by the smartphone 300 and the HMD 100. In FIG. 7, an image PT2 displayed on the display unit 330 of the smartphone 300, a right image RP2 displayed on the right display unit 22 of the HMD 100, and a left image LP2 displayed on the left display unit 24 of the HMD 100 are illustrated.

The image PT1 illustrated in FIG. 6 is an image corresponding to 3D image data in a side-by-side format, and FIG. 7 is different from FIG. 6 in that the image PT2 is an image corresponding to 2D image data. In the following, the common features with FIG. 6 are omitted in description, and differences from FIG. 6 are mainly described.

The image PT2 is not an image corresponding 3D image data in a side-by-side format, and hence the image PT2 does not include the boundary line image PCL.

The image PT2 includes the operation menu image PC. The second display controller 311 displays the operation menu image PC in an upper right region of the image PT2. Further, the second display controller 311 displays the operation menu image PC to be vertically long. The image PT includes an image PD indicating a diver.

Note that, in the present exemplary embodiment, the second display controller 311 displays the operation menu image PC in the upper right region of the image PT2. However, the second display controller 311 may display the operation menu image PC in the right region of the image PT2. Further, in a case where the second display controller 311 displays, in the image PT2, other adjustment objects different from the operation menu image PC, the second display controller 311 displays the operation menu image PC so as not to overlap with the other adjustment objects.

The first display controller 121 is set to divide the division position, the image PT2 is processed as described below. That is, the first display controller 121 of the first controller 120 of the HMD 100 generates a right image RP2 and a left image LP2 by dividing the image PT2 at the position of the center line CL. Additionally, the first display controller 121 causes the right display unit 22 to display the right image RP2, and causes the left display unit 24 to display the left image LP2. The center line CL indicates a center position of the image PT2 in the right-and-left direction.

the image PD indicating the diver is formed of a first image PD1 indicating an upper half body of the diver and a second image PD2 indicating a lower half body of the diver. The right image RP2 includes the first image PD1 and the operation menu image PC. The left image LP2 includes the second image PD2.

FIG. 8 is a diagram further illustrating another example of images displayed by the smartphone 300 and the HMD 100. In FIG. 8, the image PT1 displayed on the display unit 330 of the smartphone 300, the right image RP1 displayed on the right display unit 22 of the HMD 100, and the left image LP1 displayed on the left display unit 24 of the HMD 100 are illustrated.

The image PT1 illustrated in FIG. 6 includes the operation menu image PC, and FIG. 8 is different from FIG. 6 in that the image PT1 illustrated in FIG. 8 includes a sound volume adjustment image PS in place of the operation menu image PC. In the following, the common features with FIG. 6 are omitted in description, and differences from FIG. 6 are mainly described.

The image PT1 is an image corresponding to 3D image data in a side-by-side format. The image PT1 includes the right image RP1, the left image LP1, and a boundary line image PCL. The right image RP1 includes the sound volume adjustment image PS. The image PT1 is displayed by the second display controller 311 on the display unit 330.

When a user taps the sound volume adjustment icon PC2 of the operation menu image PC illustrated in FIG. 6, the sound volume adjustment image PS is displayed by the second display controller 311 on the display unit 330.

The second display controller 311 displays the sound volume adjustment image PS in the upper right region of the image PT1. Further, the second display controller 311 displays the sound volume adjustment image PS in a horizontally long manner. That is, the second display controller 311 displays the sound volume adjustment image PS so that a size of the sound volume adjustment image PS in the up-and-down direction is smaller than a size of the sound volume adjustment image PS in the right-and-left direction. The sound volume adjustment image PS corresponds to one example of the “adjustment object”. Further, the sound volume adjustment image PS corresponds to one example of a “slide bar object”.

The sound volume adjustment image PS includes a sound volume image PS1, a slide bar image PS2, a knob image PS3, and a sound volume display image PS4.

The sound volume image PS1 indicates that a slide bar is for adjusting sound volume. The slide bar image PS2 indicates a slide bar extending in the right-and-left direction. The knob image PS3 indicates a knob. The knob image PS3 is movable along the slide bar image PS2 in the right-and-left direction. The sound volume display image PS4 indicates a level of set sound volume.

A user slides the knob image PS3 in the right direction so as to increase sound volume. When this operation is performed, the second display controller 311 moves the knob image PS3 in the right direction to display the knob image PS3, and extends the sound volume display image PS4 in the right direction to display the sound volume display image PS4. Additionally, the second controller 310 adjusts sound data so as to increase sound volume of the sound data output from the smartphone 300 to the connection device 10. Note that, the second controller 310 may transmit, to the connection device 10, command information indicating an increase in sound volume.

Further, a user slides the knob image PS3 in the left direction so as to reduce sound volume. When this operation is performed, the second display controller 311 moves the knob image PS3 in the left direction to display the knob image PS3, and contracts the sound volume display image PS4 in the left direction to display the sound volume display image PS4. Additionally, the second controller 310 adjusts sound data so as to reduce sound volume of the sound data output from the smartphone 300 to the connection device 10. Note that, the second controller 310 may transmit, to the connection device 10, command information indicating a reduction in sound volume.

Further, the right image RP1 includes the sound volume adjustment image PS, and the right image RP1 is displayed by the first display controller 121 on the right display unit 22. Therefore, a user is allowed to visually recognize the sound volume adjustment image PS with the right eye.

In the present exemplary embodiment, description is made on the sound volume adjustment image PS as one example of the slide bar object, but the present disclosure is not limited thereto. The slide bar object may be an object for adjusting a reproduction position of an image. In this case, the slide bar object corresponds to one example of a “seek bar”.

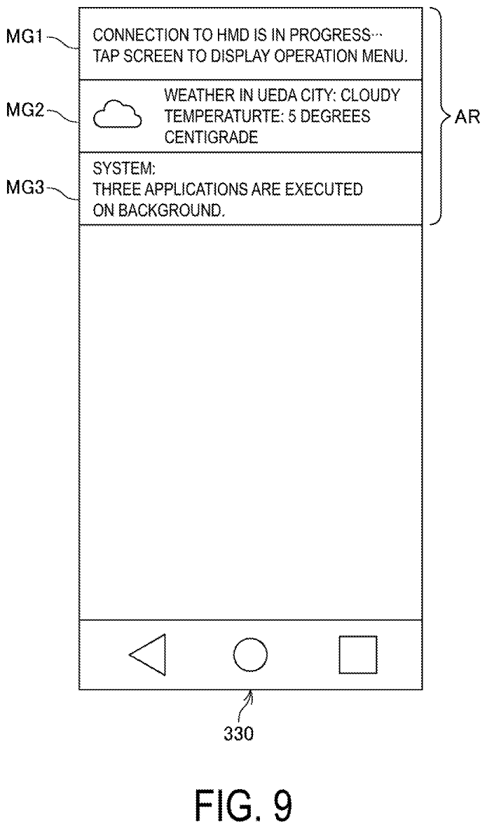

FIG. 9 is a diagram further illustrating another example of an image displayed by the smartphone 300. FIG. 9 illustrates an image displayed by the second controller 310 on the display unit 330 in a case where the smartphone 300 is connected to the HMD 100.

In the upper part of the display unit 330, a notification display region AR is set. In the notification display region AR, various messages from application programs and the like that are executed by the smartphone 300 are displayed. In the notification display region AR, a first message image MG1, a second message image MG2, and a third message image MG3 are displayed.

The first message image MG1 is displayed by the second display controller 311. The first message image MG1 indicates that the smartphone 300 is connected to the HMD 100 and that the first message image MG1 is required to be tapped to display the operation menu image PC.

Specifically, a character image “Connection to HMD is in progress” is displayed in the first message image MG1, and a user is notified that the smartphone 300 is connected to the HMD 100. Further, a character image “Tap screen to display operation menu” is displayed in the first message image MG1, and a user is notified that the first message image MG1 is required to be tapped to display the operation menu image PC.

The second message image MG2 is displayed by the second display controller 311 in accordance with an instruction from an application program. A character image “Whether in Ueda city: Cloudy, Temperature: 5 degrees centigrade” is displayed in the second message image MG2.

The third message image MG3 is displayed by the second display controller 311 in accordance with an instruction from an OS. A character image “System: Three applications are executed on background” is displayed in the third message image MG3.

### 3. Description of Processing of Second Controller

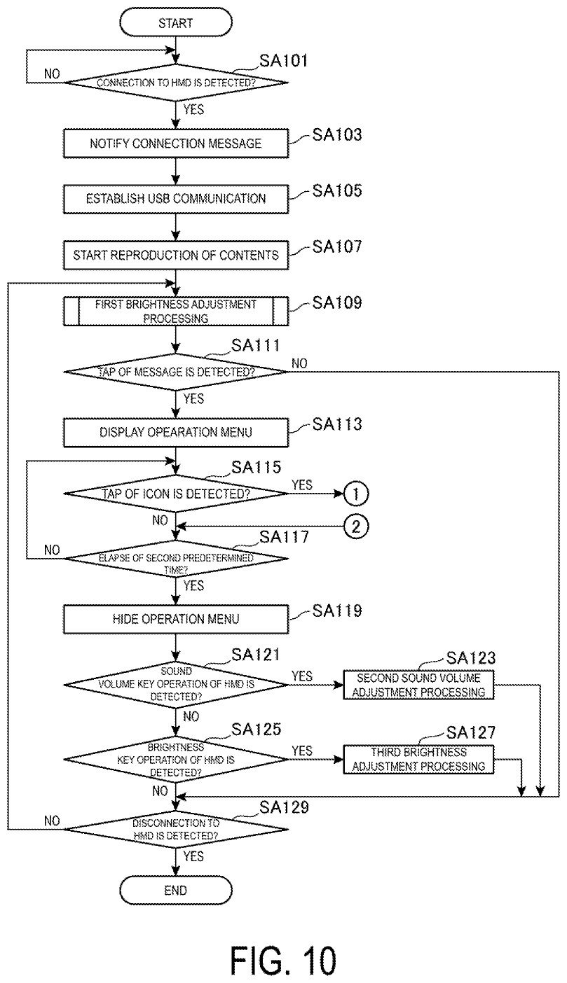

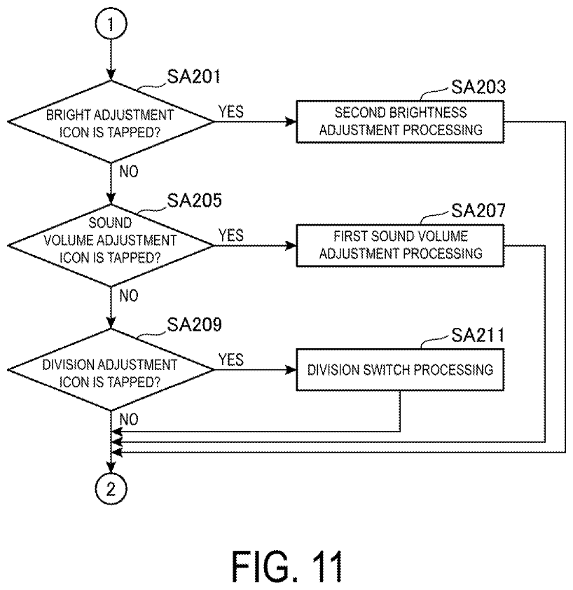

Each of FIG. 10 and FIG. 11 is a flowchart illustrating processing of the second controller 310 of the smartphone 300.

First, as illustrated in FIG. 10, in Step SA101, the detection unit 312 determines whether connection to the HMD 100 is detected.

In a case where the detection unit 312 determines that the connection to the HMD 100 is not detected (Step SA101: NO), the processing is in a standby state. In a case where the detection unit 312 determines that the connection to the HMD 100 is detected (Step SA101: YES), the processing proceeds to Step SA103.

Additionally, in Step SA103, the second display controller 311 displays, on the display unit 330, a connection message indicating that the HMD 100 is connected. Specifically, the second display controller 311 displays the first message image MG1 illustrated in FIG. 9 on the display unit 330.

Subsequently, in Step SA105, the second controller 310 establishes communication with the connection device 10 of the HMD 100 based on the USB specification. Specifically, the second controller 310 enables transmission of image data and power supply to the connection device 10 of the HMD 100. Further, the second controller 310 enables reception of operation data from the connection device 10 of the HMD 100. When a user operates the operation unit 140 of the connection device 10, the connection device 10 transmits the operation data to the second controller 310.

Subsequently, in Step SA107, the second controller 310 starts processing of reproducing the content data 321. Additionally, the second display controller 311 displays the image PT on the display unit 330, and the transmission unit 315 transmits the image data corresponding to the image PT to the HMD 100.

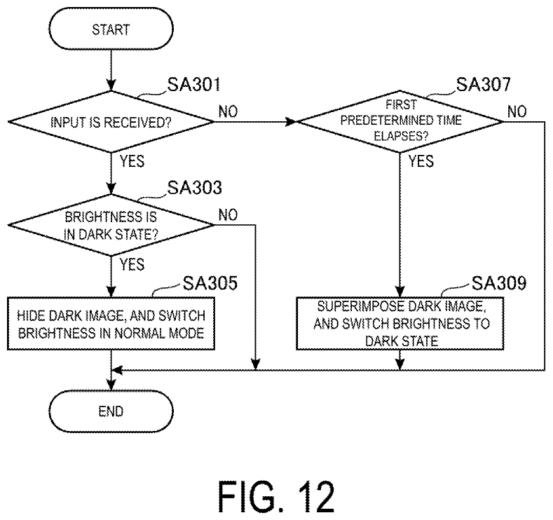

Subsequently, in Step SA109, the second controller 310 executes “first luminance adjustment processing”. The “first luminance adjustment processing” is processing the second display controller 311 reduces the luminance of the image displayed on the display unit 330 to be lower than the set luminance when the reception unit 313 does not receive an input from a user. Description is made on the “first luminance adjustment processing” later with reference to FIG. 12.

Subsequently, in Step SA111, the second controller 310 determines whether a tap on the first message image MG1 is detected via the touch sensor 332 of the display unit 330. In a case where the second controller 310 determines that a tap on the first message image MG1 is not detected (Step SA111: NO), the processing proceeds to Step SA129. In a case where the second controller 310 determines that a tap on the first message image MG1 is detected (Step SA111: YES), the processing proceeds to Step SA113.

Additionally, in Step SA113, the second display controller 311 arranges the operation menu image PC in the upper right region of the image PT, and displays the operation menu image PC on the display unit 330.

Subsequently, in Step SA115, the second controller 310 determines whether a tap on any of a plurality of icons included in the operation menu image PC is detected via the touch sensor 332 of the display unit 330. The plurality of icons are, for example, the luminance adjustment icon PC1, the sound volume adjustment icon PC2, the division adjustment icon PC3, and the adjustment icon PC4 for other conditions.

In a case where the second controller 310 determines that a tap on any of the plurality of icons included in the operation menu image PC is detected (Step SA115: YES), the processing proceeds to Step SA201 illustrated in FIG. 11. In a case where the second controller 310 determines that a tap on any of the plurality of icons included in the operation menu image PC is not detected (Step SA115: NO), the processing proceeds to Step SA117.

Additionally, in Step SA117, the second display controller 311 determines whether the second predetermined time elapses from the time at which the operation menu image PC is displayed on the display unit 330. The second predetermined time is, for example, thirty seconds.

In a case where the second display controller 311 determines that the second predetermined time does not elapse from the time at which the operation menu image PC is displayed on the display unit 330 (Step SA117: NO), the processing returns to Step SA115. In a case where the second display controller 311 determines that the second predetermined time elapses from the time at which the operation menu image PC is displayed on the display unit 330 (Step SA117: YES), the processing proceeds to Step SA119.

Additionally, in Step SA119, the second display controller 311 hides the operation menu image PC.

Subsequently, in Step SA121, the second controller 310 determines whether an operation of the sound adjustment key 15 or the sound adjustment key 16 of the HMD 100 is detected. Specifically, the second controller 310 determines whether operation data corresponding to an operation of the sound adjustment key 15 or the sound adjustment key 16 are received from the connection device 10 of the HMD 100.

In a case where the second controller 310 determines that an operation of the sound adjustment key 15 or the sound adjustment key 16 of the HMD 100 is detected (Step SA121: YES), the processing proceeds to Step SA123.

Additionally, the second controller 310 executes second sound volume adjustment processing. Specifically, the second controller 310 adjusts volume of sound to be output from the right earphone 32 and the left earphone 34 in accordance with the operation of the sound adjustment key 15 or the sound adjustment key 16 of the HMD 100. To be more specific, in a case where the operation data of the sound adjustment key 15 are received, the second controller 310 increases volume of sound to be output from the right earphone 32 and the left earphone 34. Further, in a case where the operation data of the sound adjustment key 16 are received, the second controller 310 reduces volume of sound to be output from the right earphone 32 and the left earphone 34.

In a case where the second controller 310 determines that an operation of the sound adjustment key 15 or the sound adjustment key 16 of the HMD 100 is not detected (Step SA121: NO), the processing proceeds to Step SA125.

Additionally, in Step SA125, the second controller 310 determines whether an operation of the luminance adjustment key 13 or the luminance adjustment key 14 of the HMD 100 is detected. Specifically, the second controller 310 determines whether operation data corresponding to an operation of the luminance adjustment key 13 or the luminance adjustment key 14 are received from the connection device 10 of the HMD 100.

In a case where the second controller 310 determines that an operation of the luminance adjustment key 13 or the luminance adjustment key 14 of the HMD 100 is detected (Step SA125: YES), the processing proceeds to Step SA127.

Additionally, in Step SA127, the second controller 310 executes third luminance adjustment processing. Specifically, the second controller 310 adjusts the luminance of the image PT displayed on the right display unit 22 and the left display unit 24 in accordance with an operation of the luminance adjustment key 13 or the luminance adjustment key 14 of the HMD 100. To be more specific, in a case where the operation data of the luminance adjustment key 13 are received, the second controller 310 increases luminance of the image PT to be displayed on the right display unit 22 and the left display unit 24. Further, in a case where the operation data of the luminance adjustment key 14 are received, the second controller 310 reduces the luminance of the image PT to be displayed on the right display unit 22 and the left display unit 24.

In a case where the second controller 310 determines that an operation of the luminance adjustment key 13 or the luminance adjustment key 14 of the HMD 100 is not detected (Step SA125: NO), the processing proceeds to Step SA129.

Additionally, in Step SA129, the detection unit 312 determines whether disconnection to the HMD 100 is detected.

In a case where the detection unit 312 determines that the disconnection to the HMD 100 is not detected (Step SA129: NO), the processing returns to Step SA109. In a case where the detection unit 312 determines that the disconnection to the HMD 100 is detected (Step SA129: YES), the processing is completed.

In a case where the second controller 310 determines that a tap on any of the plurality of icons included in the operation menu image PC is detected (Step SA115: YES), the following processing is executed as illustrated in FIG. 11.

That is, first, in Step SA201, the second controller 310 determines whether a tap on the luminance adjustment icon PC1 is detected.

In case where the second controller 310 determines that a tap on the luminance adjustment icon PC1 is detected (Step SA201: YES), the processing proceeds to Step SA203.

Additionally, in Step SA203, the second display controller 311 executes the third luminance adjustment processing. After that, the processing returns to Step SA117 in FIG. 10. Specifically, the second display controller 311 displays a luminance adjustment image on the display unit 330, and adjusts the luminance of the image PT to be displayed on the right display unit 22 and the left display unit 24 in accordance with an operation of the luminance adjustment image. The luminance adjustment image is displayed in a mode similar to the sound volume adjustment image PS illustrated in FIG. 8.

In a case where the second controller 310 determines that a tap on the luminance adjustment icon PC1 is not detected (Step SA201: NO), the processing proceeds to Step SA205.

Additionally, in Step SA205, the second controller 310 determines whether a tap on the sound volume adjustment icon PC2 is detected.

In a case where the second controller 310 determines that a tap on the sound volume adjustment icon PC2 is detected (Step SA205: YES), the processing proceeds to Step SA207.

Additionally, in Step SA207, the second controller 310 executes the first sound volume adjustment processing. After that, the processing returns to Step SA117 in FIG. 10. Specifically, the second controller 310 displays the sound volume adjustment image PS on the display unit 330, and adjusts volume of sound to be output from the right earphone 32 [symbol] the left earphone 34 in accordance with an operation of the sound volume adjustment image PS.

In a case where the second controller 310 determines that a tap on the sound volume adjustment icon PC2 is not detected (Step SA205: NO), the processing proceeds Step SA209.

Additionally, in Step SA209, the second controller 310 determines whether a tap on the division adjustment icon PC3 is detected.

In a case where the second controller 310 determines that a tap on the division adjustment icon PC3 is detected (Step SA209: YES), the processing proceeds to Step SA211.

Additionally, in Step SA211, the second controller 310 executes division switch processing. After that, the processing returns to Step SA117 in FIG. 10. Specifically, in a case where the first display controller 121 is set to divide the image PT, the second controller 310 switches to a setting that the first display controller 121 does not divide the image PT. In a case where the first display controller 121 is set not to divide the image PT, the second controller 310 switches to a setting that the first display controller 121 divides the image PT.

In a case where the second controller 310 determines that a tap on the division adjustment icon PC3 is not detected (Step SA209: NO), the processing returns to Step SA117 in FIG. 10.

FIG. 12 is a flowchart illustrating “first luminance adjustment processing” of the second controller 310.

The “first luminance adjustment processing” described below is performed in Step SA109 in FIG. 10.

First, in Step SA301, the reception unit 313 determines whether an operation input by a user is received via the touch sensor 332 of the display unit 330.

In a case where the reception unit 313 determines that an operation input by a user is not received (Step SA301: NO), the processing proceeds to Step SA307. In a case where the reception unit 313 determines that an operation input by a user is received (Step SA301: YES), the processing proceeds to Step SA303.

Additionally, in Step SA303, the second display controller 311 determines whether the luminance is in a dark state. Here, the expression “the luminance is in a dark state” indicates a state in which the luminance of the image displayed on the display unit 330 is lowered by virtually superimposing, on the upper layer of the image PT displayed on the display unit 330, a layer on which a gray image with a predetermined density is formed.

In a case where the second display controller 311 determines that the luminance is not in a dark state (Step SA303: NO), the processing proceeds to Step SA111 in FIG. 10. In a case where the second display controller 311 determines that the luminance is in a dark state (Step SA303: YES), the processing proceeds to Step SA305.

Additionally, in Step SA305, the second display controller 311 turns the luminance of the image PT displayed on the display unit 330 to a normal state by hiding the dark image. After that, the processing proceeds to Step SA111 in FIG. 10.

In a case where the reception unit 313 determines that an operation input by a user is not received (Step SA301: NO), in Step SA307, the second display controller 311 determines whether a first predetermined time elapses from the time at which the reception unit 313 receives an operation input by a user. The first predetermined time is, for example, ten seconds.

In a case where the second display controller 311 determines that the first predetermined time does not elapse from the time at which the reception unit 313 receives an operation input by a user (Step SA307: NO), the processing proceeds to Step SA111 in FIG. 10. In a case where the second display controller 311 determines that the first predetermined time elapses from the time at which the reception unit 313 receives an operation input by a user (Step SA307: YES), the processing proceeds to Step SA309.

Additionally, in Step SA309, the second display controller 311 reduces the luminance of the image PT displayed on the display unit 330 by virtually superimposing, on the upper layer of the image PT displayed on the display unit 330, the layer on which the dark image is formed. After that, the processing proceeds to Step SA111 in FIG. 10.

### 4. Description of Processing of First Controller

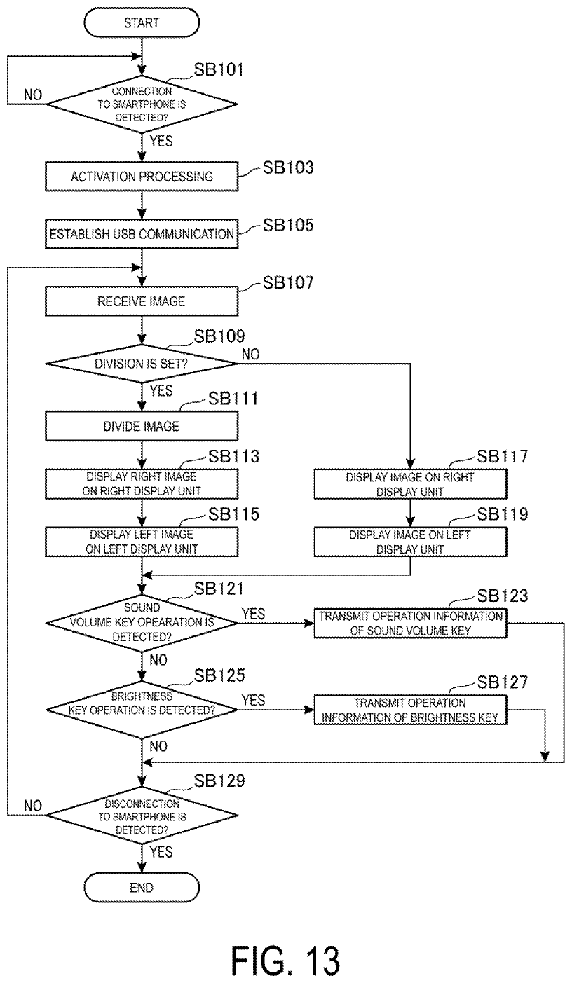

FIG. 13 is a flowchart illustrating processing of the first controller 120 of the HMD 100.

First, in Step SB101, the first controller 120 determines whether connection to the smartphone 300 is detected.

In a case where the first controller 120 determines that connection to the smartphone 300 is not detected (Step SB101: NO), the processing is in a standby state. In a case where the first controller 120 determines that connection to the smartphone 300 is detected (Step SB101: YES), the processing proceeds to Step SB103.

Additionally, in Step SB103, the first controller 120 executes activation processing of the HMD 100.

Subsequently, in Step SB105, the first controller 120 establishes communication with the smartphone 300 based on the USB specification.

Subsequently, in Step SB107, the reception unit 123 receives an image from the smartphone 300.

Subsequently, in Step SB109, the first display controller 121 determines whether the first display controller 121 is set to divide the received image PT.

In a case where the first display controller 121 determines that the first display controller 121 is not set to divide the received image PT (Step SB109: NO), the processing proceeds to Step SB117. In a case where the first display controller 121 determines that the first display controller 121 is set to divide the received image PT (Step SB109: YES), the processing proceeds to Step SB111.

Additionally, in Step SB111, the first display controller 121 generates the right image RP and the left image LP by dividing the image PT at the set division position.

Subsequently, in Step SB113, the first display controller 121 causes the right display unit 22 to display the right image RP.

Subsequently, in Step SB115, the first display controller 121 causes the left display unit 24 to display the left image LP, and then the processing proceeds to Step SB121.

In a case where the first display controller 121 determines that the first display controller 121 is not set to divide the received image PT (Step SB109: NO), in Step SB117, the first display controller 121 causes the right display unit 22 to display the image PT.

Subsequently, in Step SB119, the first display controller 121 causes the left display unit 24 to display the image PT.

Subsequently, in Step SB121, the first controller 120 determines whether an operation of the sound adjustment key 15 or the sound adjustment key 16 is detected.

In a case where the first controller 120 determines that an operation of the sound adjustment key 15 or the sound adjustment key 16 is detected (Step SB121: YES), the processing proceeds to Step SB123.

Additionally, in Step SB123, the first controller 120 transmits, to the smartphone 300, operation data indicating an operation of the sound adjustment key 15 or the sound adjustment key 16.

In a case where the first controller 120 determines that an operation of the sound adjustment key 15 or the sound adjustment key 16 is not detected (Step SB121: NO), the processing proceeds to Step SB125.

Additionally, in Step SB125, the first controller 120 determines whether an operation of the luminance adjustment key 13 or the luminance adjustment key 14 is detected.

In a case where the first controller 120 determines that an operation of the luminance adjustment key 13 or the luminance adjustment key 14 is not detected (Step SB125: NO), the processing proceeds to Step SB129.

In a case where the first controller 120 determines that an operation of the luminance adjustment key 13 or the luminance adjustment key 14 is detected (Step SB125: YES), the processing proceeds to Step SB127.

Additionally, in Step SB127, the first controller 120 transmits, to the smartphone 300, operation data indicating an operation of the luminance adjustment key 13 or the luminance adjustment key 14.

Subsequently, in Step SB129, the first controller 120 determines whether disconnection to the smartphone 300 is detected. Note that, “disconnection to the smartphone 300” indicates that connection to the smartphone 300 is canceled.

In a case where the first controller 120 determines that disconnection to the smartphone 300 is not detected (Step SB129: NO), the processing returns to Step SB107. In a case where the first controller 120 determines that disconnection to the smartphone 300 is detected (Step SB129: YES), the processing is completed.

Step SA113 in FIG. 10 corresponds to one example of an “arrangement step”, and Step SA107 in FIG. 10 corresponds to one example of a “transmission step”. Step SB107 in FIG. 13 corresponds to one example of a “reception step”, and Step SB111, Step SB113, and Step SB115 in FIG. 13 correspond to examples of a “display step”.

### 5. Effects of Present Exemplary Embodiment

As described above, in the present exemplary embodiment, in the HMD 100, the reception unit 123 receives the image PT from the smartphone 300. Additionally, the first display controller 121 generates two divided images by dividing the image PT at the set division position, and causes the image display unit 20 to display the respective divided images. Note that, the division position is, for example, the position of the center line CL. The two divided images are the right image RP and the left image LP. The first display controller 121 causes the right display unit 22 to display an image based on one piece of the divided image data, that is, the right image RP, and causes the left display unit 24 to display an image based on the other piece of the divided image data, that is, the left image LP. Further, in the smartphone 300, the transmission unit 315 transmits image data corresponding to the image PT to the HMD 100. Additionally, the second display controller 311 causes the image PT to include the adjustment object for adjusting the image PT, and separates the position of the adjustment object away from the position corresponding to the division position. The adjustment object is, for example, the operation menu image PC.

Thus, in the image PT displayed by the HMD, the adjustment object such as the operation menu image PC is arranged at an appropriate position. Therefore, degradation of operability for the user can be suppressed. Further, in a case where the image PT is an image corresponding to 3D image data in a side-by-side format, a user can visually recognize a 3D image corresponding to 3D image data. Therefore, convenience for the user can be improved.

Further, the control method of the display system 1, the smartphone 300, and the control program of the smartphone 300 according to the present exemplary embodiment can obtain similar effects to those described above.

Further, the transmission unit 315 transmits, to the HMD 100, the image PT displayed on the display unit 330 of the smartphone 300.

Thus, the image PT that corresponds to the plurality of divided images displayed on the image display unit 20 of the HMD 100 can be displayed on the display unit 330. Therefore, a user is allowed to visually recognize the image PT on the display unit 330 of the smartphone 300. As a result, operability for the user can be improved.

Further, the second display controller 311 of the smartphone 300 displays the adjustment object such as the operation menu image PC in the right region of the image PT.

In general, an extent to which a user fixates on an object is highest in the upper left region in the image PT, and is lower in the upper right region, the lower left region, and the lower right region, in the stated order. Thus, the adjustment object such as the operation menu image PC is displayed in the right region in the image PT, and hence a user is allowed to visually recognize the adjustment object with moderate attention. Thus, operability for the user can be improved.

Further, the second display controller 311 of the smartphone 300 displays the adjustment object such as the operation menu image PC in the upper right region of the image PT.

In general, an extent to which a user pays attention is highest in the upper left region in the image PT, and is lower in the upper right region, the lower left region, and the lower right region, in the stated order. Thus, the adjustment object such as the operation menu image PC is displayed in the upper right region in the image PT, and hence a user is further allowed to visually recognize the adjustment object with moderate attention. Thus, operability for the user can be improved.

Further, the second display controller 311 of the smartphone 300 displays the adjustment object such as the operation menu image PC so as not to overlap with other adjustment objects.

Therefore, degradation of operability of the adjustment object, which is caused by the adjustment object overlapping with other adjustment objects, can be suppressed.

Further, the second display controller 311 of the smartphone 300 displays the adjustment object such as the operation menu image PC to be vertically long.

In general, in the image PT, an important image is arranged at the center of the image in the right-and-left direction. Thus, the adjustment object such as the operation menu image PC is displayed to be vertically long, and hence the adjustment object is separated from an important image in the image PT, and can be arranged in, for example, the upper right region of the image PT. Therefore, degradation of visual recognition of the image PT by the user can be suppressed.

Further, in a case where the reception unit 313 receives an input, the second display controller 311 of the smartphone 300 displays the adjustment object such as the operation menu image PC. Further, in a case where the reception unit 313 does not receive an input, the second display controller 311 does not display the adjustment object such as the operation menu image PC.

Therefore, in a case where the reception unit 313 receives an input, the adjustment object such as the operation menu image PC is displayed. Thus, a user is allowed to operate the adjustment object such as the operation menu image PC. Further, in a case where the reception unit 313 does not receive an input, the second display controller 311 does not display the adjustment object such as the operation menu image PC. Thus, degradation of visual recognition of the image PT, which is caused by the adjustment object, can be suppressed.

Further, in a case where the detection unit 312 detects connection to the HMD 100, the second display controller 311 of the smartphone 300 reduces the luminance of the image PT displayed on the display unit 330 to be lower than the set luminance.

Thus, consumption of a battery of the smartphone 300, which is caused by display of the image PT on the display unit 330, can be suppressed. Therefore, reduction of a residual amount of the battery of the smartphone 300 can be suppressed.

Further, the second display controller 311 of the smartphone 300 visually superimposes, on the upper layer of the image displayed on the display unit 330, the layer on which the dark image is formed. In this manner, the second display controller 311 reduces the luminance of the image displayed on the display unit 330.

Therefore, the luminance of the image displayed on the display unit 330 can be lowered with simple processing. Further, the layer on which the dark image is formed is virtually removed. In this manner, the luminance of the image displayed on the display unit 330 can be restored with simple processing.

Further, the adjustment object includes a slide bar object. The sound volume adjustment image PS described with reference to FIG. 8 corresponds to one example of a slide bar object. The slide bar object includes a slide bar object image extending in the right-and-left direction of the image PT.

Therefore, operability of an operation of sound volume adjustment and the like with the slide bar object can be secured.

### 6. Other Embodiments

The present disclosure is not limited to the configurations in the exemplary embodiment described above, and can be implemented in various aspects without departing from the gist of the present disclosure.

For example, in the present exemplary embodiment, the division position is at the position of the center line CL, but is not limited thereto. For example, the division position may be a center position of the image PT in the up-and-down direction.

Further, in the present exemplary embodiment, the second display controller 311 of the smartphone 300 displays the adjustment object such as the operation menu image PC in the upper right region of the image PT, but the present disclosure is not limited thereto. The second display controller 311 of the smartphone 300 is only required to separate the position of the adjustment object such as the operation menu image PC away from the position corresponding to the division position of the image PT. For example, the second display controller 311 may display the operation menu image PC in the right region or the left region of the image PT. In other words, the second display controller 311 is only required to display the operation menu image PC so as not to overlap with the position of the center line CL.

Further, in the present exemplary embodiment, the second display controller 311 of the smartphone 300 displays the image PT on the display unit 330, but the present disclosure is not limited thereto. The second display controller 311 of the smartphone 300 may display an error image indicating occurrence of an error on the display unit 330 in accordance with occurrence of an error in the HMD 100. That is, the second display controller 311 may display an error image in place of or in addition to the image PT.

Note that, an error indicates, for example, that a temperature of the HMD 100 reaches or exceeds a predetermined threshold value. Further, in this case, the error image may be a character image “The function is deactivated due to high temperature of the HMD. Retry connection after a while”.

Thus, occurrence of an error in the HMD 100 can be notified by the display unit 330 of the smartphone 300. Accordingly, convenience for the user can be improved.

Further, in the present exemplary embodiment, the second display controller 311 of the smartphone 300 displays the adjustment object such as the operation menu image PC to be vertically long, but the present disclosure is not limited thereto. The second display controller 311 may display the adjustment object such as the operation menu image PC in a horizontally long manner or in a square shape.

Further, in the present exemplary embodiment, the “information processing device” corresponds to the smartphone 300, but the present disclosure is not limited thereto. The “information processing device” is only required to include a controller, a display unit, and a power source. For example, the “information processing device” may be a tablet-type personal computer or a notebook-type personal computer.

Further, in the exemplary embodiment described above, the configuration in which the connection device 10 is connected to the image display unit 20 by wire is illustrated. However, the present disclosure is not limited thereto, and the image display unit 20 may be connected wirelessly to the connection device 10.

Further, a part of the functions of the connection device 10 may be provided in the image display unit 20. The connection device 10 may be achieved by a plurality of devices. For example, in place of the connection device 10, a wearable device that can be attached to the body or clothes of the user, or to the personal adornments worn by the user may be used. The wearable device in such a case may be, for example, a watch-like device, a ring-like device, a laser pointer, a mouse, an air mouse, a game controller, a pen-like device, or the like.

In addition, in the exemplary embodiment described above, description is made on the configuration in which the image display unit 20 and the connection device 10 are separated from each other, and are connected via the connection cable 40 as an example. The present disclosure is not limited thereto, and a configuration in which the connection device 10 and the image display unit 20 are integrally formed to be mounted on a head of a user may be adopted.

Further, in the exemplary embodiment described above, the configuration in which the user views an outside scene through the display unit is not limited to the configuration in which the right light-guiding plate 26 and the left light-guiding plate 28 transmit outside light. For example, the present disclosure is applicable to a display device configured to display an image under a state in which an outside scene cannot be visually recognized. Specifically, the present disclosure is applicable to a display device configured to display, for example, an image captured by the camera 61, an image or CG generated based on the captured image, and a moving image based on image data stored in advance or movie data input from outside. This kind of display device may include a so-called closed type display device in which an outside scene cannot be visually recognized. For example, with a configuration in which a composite image created by combining together an image of an outside scene captured by the camera 61 and a display image is displayed on the image display unit 20, the display device is capable of displaying the outside scene and the image so as to be visually recognizable for by the user even when the image display unit 20 may not transmit outside light. Of course, it is also possible to apply the present disclosure to such a so-called video see-through type display device.

Additionally, for example, in place of the image display unit 20, an image display unit of another type such as an image display unit worn as a hat may be adopted, and is only required to include a display unit that displays an image in correspondence to the left eye LE of the user and a display unit that displays an image in correspondence to the right eye RE of the user. Additionally, the display device may be configured, for example, as an HMD mounted on a vehicle such as a car and an airplane. Further, the display device may be configured, for example, as an HMD built into a body protector tool such as a helmet. In this case, a portion that performs positioning with respect to a body of a user and a portion to be positioned by the positioning portion may be mounting portions.

Further, the configuration in which a virtual image is formed by the half mirrors 261 and 281 on parts of the right light-guiding plate 26 and the left light-guiding plate 28 is exemplified as an optical system that guides imaging light to the eyes of the user. The present disclosure is not limited thereto, and there may be adopted a configuration in which an image is displayed either on the entire surfaces of the right light-guiding plate 26 and the left light-guiding plate 28 or in a display region having an area that occupies most part of the right light-guiding plate 26 and the left light-guiding plate 28. In such a case, processing for reducing an image may be included in an operation for changing a display position of the image.

In addition, the optical elements are not limited to the right light-guiding plate 26 and the left light-guiding plate 28 including half mirrors 261 and 281, and any optical components that allow the imaging light to enter the eyes of the user, specifically, diffraction grating, prisms, and holographic display units may be employed.

In addition, there may be adopted a configuration in which at least some of the function blocks illustrated in FIG. 4, FIG. 5, and the like are achieved with hardware, or achieved together with hardware and software, and the present disclosure is not limited to a configuration in which independent hardware resources are arranged as illustrated in the drawings.

Further, a control program executed by the second controller 310 may be stored in the non-volatile storage unit 320 or another storage unit in the second controller 310. Further, there may be adopted a configuration in which a control program stored in an external device is acquired via the communication unit 345 or the like so as to be executed. Further, among the configurations formed in the second controller 310, the reception unit 313 may be formed as a user interface (UI).

Further, a duplicate of a configuration formed in the connection device 10 may be formed in the image display unit 20. For example, a processor similar to the processor of the connection device 10 may be arranged in the image display unit 20, or the processor of the connection device 10 and the processor of the image display unit 20 may perform separate functions.

Further, processing units in the flowchart illustrated in FIG. 10 to FIG. 13 are obtained by dividing the processing based on main processing contents in order to facilitate the understanding of the processing in the smartphone 300 or the HMD 100. The example embodiment is not limited by a manner of dividing the processing units or names illustrated in the flowcharts in FIG. 10 to FIG. 13. Further, the processing of the first controller 120 and the processing of the second controller 310 may be divided into more processing units in accordance with processing contents, and may be divided such that one processing unit includes more processing. Further, an order of the processing in the above-described flowchart is also not limited to the illustrated example.

Further, the control method of the display system 1 according to the present disclosure can be achieved by causing the computers of the display devices in the display system 1 to execute a program corresponding to the control method of the display system 1. Furthermore, the program can also be recorded in a recording medium recorded so as to be readable by a computer. The recording medium may be a magnetic recording medium, an optical recording medium, or a semiconductor memory device. Specifically, a portable or stationary type recording medium, such as a flexible disk, a Compact Disk Read Only Memory (CD-ROM), a DVD, a Blu-ray (trade name) Disc, a magneto-optical disc, a flash memory, and a card type recording medium, may be exemplified. Further, the recording medium may be a non-volatile storage device such as a RAM, a ROM, and an HDD, all representing internal storages of an image display device. Further, the program corresponding to the control method of the display system 1 may be stored in a server device or the like, and the control method of the display system 1 may be achieved by downloading the program from the server device to the display devices in the display system 1.

What is claimed is:

1. A display system constituted by an information processing device and a display device connected to each other,
the display device, comprising:
a first display unit configured to display an image, the first display unit being mounted on a head of a user;
a reception unit configured to receive an image from the information processing device; and
a first controller configured to divide the image, at a set division position, into two divided images, and cause the first display unit to display each of the divided images, wherein
the first display unit includes a right-eye display unit that emits imaging light to a right eye of the user and a left-eye display unit that emits imaging light to a left eye of the user,
the first controller divides image data corresponding to the image received by the reception unit into two pieces to generate two pieces of divided image data, causes the right-eye display unit to display an image based on one piece of the divided image data, and causes the left-eye display unit to display an image based on the other piece of the divided image data,
the information processing device includes
a transmission unit that transmits the image to the display device, and
a second control unit that includes an adjustment object in the image, and
the second controller separates a position of the adjustment object away from a position corresponding to the division position.

2. The display system according to claim 1, wherein
the information processing device includes a second display unit that displays an image, and
the second controller causes the transmission unit to transmit, to the display device, the image to be displayed on the second display unit.

3. The display system according to claim 1, wherein the second controller of the information processing device displays the adjustment object in a right region of the image.

4. The display system according to claim 3, wherein the second controller of the information processing device displays the adjustment object in an upper right region of the image.

5. The display system according to claim 1, wherein the second controller of the information processing device displays the adjustment object so that the adjustment object does not overlap another adjustment object.

6. The display system according to claim 1, wherein the second controller of the information processing device displays the adjustment object to be vertically long.

7. The display system according to claim 1, wherein
the second controller of the information processing device includes a reception unit that receives an input, and
the second controller of the information processing device displays the adjustment object when the reception unit receives an input, and does not display the adjustment object when the reception unit does not receive an input.

8. The display system according to claim 2, wherein
the second controller of the information processing device includes a detection unit that detects that the display device is connected, and
the second controller of the information processing device reduces luminance of the image displayed on the second display unit, in accordance with a detection result of the detection unit, to be lower than set luminance.

9. The display system according to claim 8, wherein the second controller of the information processing device superimposes an image with a predetermined density on the image to reduce the luminance of the image displayed on the second display unit.

10. The display system according to claim 1, wherein
the adjustment object includes a slide bar object, and
the slide bar object includes a slide bar image extending in a right-and-left direction of the image.

11. The display system according to claim 2, wherein the second controller of the information processing device displays an error image on the second display unit in accordance with occurrence of an error in the display device, the error image indicating the occurrence of the error.

12. A control method of a display system constituted by an information processing device and a display device mounted on a head of a user connected to each other, the control method comprising:
an arranging step for, by the information processing device, including an adjustment object in an image and separating a position of the adjustment object away from a position corresponding to a set division position;
a transmitting step for transmitting the image to the display device by the information processing device;
a receiving step for receiving the image by the display device; and
a displaying step for, by the display device, dividing the image at the division position into two divided images and displaying each of the divided images, wherein
in the displaying step, the display device divides image data corresponding to the image into two pieces to generate two pieces of divided image data, causes a right-eye display unit to display an image based on one piece of the divided image data, and causes a left-eye display unit to display an image based on the other piece of the divided image data.

13. An information processing device connected to a display device that is mounted on a head of a user, divides an image at a set division position to generate two divided images, and displays each of the divided images, the information processing device comprising:
a transmission unit configured to transmit the image to the display device; and
a display controller configured to include an adjustment object in the image and separate a position of the adjustment object away from a position corresponding to the division position.

14. A non-transitory computer-readable storage medium storing a control program of an information processing device including a computer, the information processing device being connected to a display device that is mounted on a head of a user, divides an image at a set division position to generate a plurality of divided images, and displays each of the divided images, the control program being configured to cause the computer to function as:
a transmission unit configured to transmit the image to the display device; and
a display controller configured to separate a position of an adjustment object away from a position corresponding to the division position when the adjustment object is included in the image.
